(19) United States
(12) Patent Application Publication
(10) Pub. No.: US 2010/0233067 A1
(43) Pub. Date: Sep. 16, 2010

(54) METHOD OF PRODUCING CUP-SHAPED NANOCARBON AND CUP-SHAPED NANOCARBON

(75) Inventors: Shunichi Fukuzumi, Suita-shi (JP); Kenji Saito, Suita-shi (JP); Masataka Ohtani, Suita-shi (JP)

Correspondence Address: HAMRE, SCHUMANN, MUELLER & LARSON, P.C., P.O. BOX 2902, MINNEAPOLIS, MN, 55402-0902, US

(73) Assignee: Osaka University, Suita-shi, Osaka (JP)

(21) Appl. No.: 12/307,086

(22) PCT Filed: Jan. 5, 2007
(86) PCT No.: PCT/JP2007/050023

§ 371 Date: Dec. 30, 2008

(30) Foreign Application Priority Data
Jul. 7, 2006 (JP) 2006-187853

(51) Int. Cl. D01F 9/12; B32B 37/14

(52) U.S. Cl. 423/447.2; 156/293; 977/700; 977/742

(57) ABSTRACT

A method of producing of the present invention is a method of producing a cup-shaped nanocarbon formed of graphene sheets. A nanocarbon molecule has a cup shape, a bottom surface and an upper surface thereof being opened. The method of producing of the present invention includes the following processes (A) and (B).
(A) a process of preparing a cup-stacked carbon nanotube, in which cup-shaped nanocarbons having openings at the bottom surface and the upper surface are laminated; and
(B) a process of separating the cup-shaped nanocarbon from the cup-stacked carbon nanotube by treating the cup-stacked carbon nanotube with a reducing agent.

### BACKGROUND OF THE INVENTION

1. Technical Field

The present invention relates to a method of producing a cup-shaped nanocarbon and a cup-shaped nanocarbon.

2. Background Art

A carbon nanotube is formed from the allotropes of carbon as well as diamond, graphite, fullerene, etc. Generally, examples of the carbon nanotube include multilayer carbon nanotube, single layer carbon nanotube, cup-stacked carbon nanotube, etc.

The single layer carbon nanotube is a molecule formed of graphene sheets and has a hollow cylindrical form. The graphene sheet generally is composed of sp² hybrid carbon atom. The atoms, hexagonally and pentagonally arranged, have a planar network arrangement. Further, there is a graphene sheet containing the atoms arranged in another polygonal shape such as heptagon, octagon, etc. The diameter of the single layer carbon nanotube is normally in the range of about 0.5 to about 10 nm and specifically in the range of 0.5 to 3 nm. Further, the length of the single layer carbon nanotube is normally more than about 50 nm.

The multilayer carbon nanotube is, for example, a molecule formed of multilayer graphene sheets, and has a structure in which the graphene sheets are laminated in coaxial cylinders. Examples of the multilayer carbon nanotube include a two-layer carbon nanotube and a three-layer carbon nanotube. Further, there is a multilayer carbon nanotube composed of several hundred-layer graphene sheets. The diameter of the multilayer carbon nanotube is normally larger than that of the single layer carbon nanotube.

The cup-stacked carbon nanotube has a structure in which plural cup-shaped nanocarbons formed of graphene sheets are laminated in the height direction of the cup. The cup-stacked carbon nanotube is fiber carbon particles. Normally, in the cup-stacked carbon nanotube, several to several hundred cup-shaped nanocarbons are laminated.

The carbon nanotube has excellent electrical and thermal conductivity, and high tensile strength. Further, the carbon nanotube is excellent in toughness and flexibility, and is chemically stable. The allowable current density of the carbon nanotube is large. Further, the thermal conductivity of the carbon nanotube is equal to or more than diamond, for example.

The carbon nanotube attracts attention as functional materials, for example. Examples of the functional materials include molecular devices capable of ultra high integration, storage materials for various gasses such as hydrogen, field emission display (FED) members, electronic materials, electrode materials, additives for resin molding, etc.

An example of a method of producing a carbon nanotube includes a chemical vapor deposition method (CVD). For example, the CVD is adopted when the carbon nanotube is prepared on a supported metallic catalyst. In this method, first, nanometer scale particles of the catalytic metal are supported on a substrate. Then, on the catalytic metal particles, gaseous carbon-containing molecule is reacted and the carbon nanotube is produced. This method has been used for producing the multilayer carbon nanotube. Further, with this method, an excellent single layer carbon nanotube also can be produced under specific reaction conditions. The synthesis of a small diameter carbon nanotube by the CVD method is disclosed in Non-patent Document 1 and Patent Document 1. Examples of the carbon nanotube obtained by the CVD method include a single layer carbon nanotube, a small diameter multilayer carbon nanotube, residual catalytic metal particles, catalyst support materials, amorphous carbon, and untubed fullerene, etc. The carbon nanotube can be synthesized by an arc discharge method, a laser vaporization method, etc. A method of producing a cup-stacked carbon nanotube is disclosed in Non-patent Document 2. This method of producing a cup-stacked carbon nanotube is basically the CVD method.

In Patent Document 2, an electrolytic composition, in which a cup-stacked carbon nanotube is contained in electrolyte, is disclosed. The electrolyte is an electrolyte used for dye-sensitized solar cell, for example. The cup-stacked carbon nanotube plays the role of charge transfer, and the electric resistance thereof is lower than ionic liquid. Therefore, the electrolytic composition has superior electrical conductivity. As a result, the electrolytic composition using the cup-stacked carbon nanotube can improve conversion efficiency of photoelectric conversion element better than the case in which ionic liquid is used as the electrolyte.

Further, studies have been made to apply a cup-stacked carbon nanotube supporting platinum or ruthenium to a fuel cell electrode.

In Non-patent Document 3, a method, in which C₆₀ is reduced by N-benzyl-1,4-dihydronicotinamide, N-benzyl-1,4-dihydronicotinamide dimer, etc. under light irradiation, is disclosed.

In Non-patent Document 4, a method, in which a single layer carbon nanotube is n-dodecylated, is disclosed. In this document, a method, in which the single layer carbon nanotube is reduced by lithium metal, sodium metal, or potassium metal in liquid ammonia, is disclosed. Due to this reduction reaction, single layer carbon nanotube anion suspension is produced. An alkyl group (dodecyl group) is introduced to the single layer carbon nanotube by adding 1-iodo n-dodecane to this suspension.

In Non-patent Document 5, a method, in which a single layer carbon nanotube is reduced by lithium or sodium, is disclosed. In this document, due to this reduction reaction, the single layer carbon nanotube is anionized and dissolved in aprotic solvent.

Among carbon nanotubes, the cup-stacked carbon nanotube is promising as materials for various purposes such as electronic materials.

### [Patent Document 1] WO00/17102A1

### [Patent Document 2] JP2005-93075A

[Non-patent Document 1] Dai et al., Chem. Phys. Lett., Vol. 260, pp. 471-475, 1996
[Non-patent Document 2] Endo, M et al., Appl. Phys. Lett., 2002, 80, 1267
[Non-patent Document 3] Fukuzumi et al., J. Am. Chem. Soc. 1998, 120, 8060-8068
[Non-patent Document 4] Feng Liang et al., J. Am. Chem. Soc. 2005, 127, 13941-13948
[Non-patent Document 5] Main Penicausd et al., J. Am. Chem. Soc. 2005, 127, 8-9

### DISCLOSURE OF INVENTION

Hence, a further change of the characteristics of the cup-stacked carbon nanotube is required. An example of a method for changing the characteristics includes a method for modifying the cup-stacked carbon nanotube by substituent. A further example of the method for changing the characteristics includes a method for solubilizing the cup-stacked carbon nanotube. Solubilization of the cup-stacked carbon nanotube makes it possible to ease a reaction in which the substituent is introduced into the carbon nanotube.

However, as described above, the cup-stacked carbon nanotube has a structure in which cup-shaped nanocarbons are laminated in the height direction of the cup. For example, plural cup-shaped nanocarbons are laminated like a state in which cups are piled up. Specifically, with respect neighboring two cup-shaped nanocarbons, a bottom portion of one cup-shaped nanocarbon is inserted into the other cup-shaped nanocarbon. Therefore, the bottom portion inserted into the other cup-stacked nanocarbon is not exposed outwardly. Introduction of the substituent to the area that is not outwardly exposed is difficult. Accordingly, change of characteristics of the cup-stacked carbon nanotube by introducing the substituent is difficult.

The inventors considered using the cup-shaped nanocarbon that configures the cup-stacked carbon nanotube as new functional materials for various purposes. However, a method of separating the cup-stacked carbon nanotube into the cup-shaped nanocarbon is not reported. Further, a method of producing the individually presented cup-shaped nanocarbon without laminating is also not reported.

Hence, the present invention is intended to provide a method of producing a cup-shaped nanocarbon presenting individually by separating individual cup-shaped nanocarbon from a cup-stacked carbon nanotube.

In order to solve the aforementioned problems, a method of producing of the present invention is a method of producing a cup-shaped nanocarbon, wherein the method comprises the following processes (A) and (B):
(A) a process of preparing a cup-stacked carbon nanotube configured by laminating more than one cup-shaped nanocarbons in a height direction of a cup; and
(B) a process of separating the cup-shaped nanocarbon from the cup-stacked carbon nanotube by a reduction treatment of the cup-stacked carbon nanotube.

The method of producing a cup-shaped nanocarbon of the present invention is a method of separating individual cup-shaped nanocarbon from a cup-stacked carbon nanotube.

A cup-shaped nanocarbon of the present invention is a molecule produced by a method of producing of the present invention. Further, the cup-shaped nanocarbon of the present invention is a negatively-charged anionic molecule. Moreover, the cup-shaped nanocarbon of the present invention is a derivative having a substituent.

According to the method of producing of the present invention, a cup-shaped nanocarbon can be produced by applying a reduction treatment to a cup-stacked carbon nanotube. A cup-shaped nanocarbon obtained by the method of producing of the present invention is individually separated. Conventionally, a cup-shaped nanocarbon that configures a cup-stacked carbon nanotube could not present in an individually separated manner, although the mechanism was unknown. The cup-shaped nanocarbon was simply presented as a building block of the carbon nanotube. In contrast, according to the method of producing of the present invention, a cup-shaped nanocarbon can be produced that is presented not as a building block of the cup-stacked carbon nanotube but as one material. In this manner, a method of producing an individually separated cup-shaped nanocarbon by a reduction treatment was found for the first time by the inventors of the present invention.

Since the cup-shaped nanocarbon obtained by the present invention is individually separated, for example, the cup-shaped nanocarbon obtained by the present invention is much easier to handle than the cup-stacked carbon nanotube. This is because the cup-shaped nanocarbon has better performance in solubility and dispersibility relative to the solvent than the cup-stacked carbon nanotube. Further, the cup-shaped nanocarbon of the present invention is not laminated with other cup-shaped nanocarbons. Therefore, unlike a cup-shaped nanocarbon that forms the cup-stacked carbon nanotube, all constituent atoms of the cup-shaped nanocarbon of the present invention are exposed. Therefore, chemical modification of the cup-shaped nanocarbon by introducing a substituent can easily be carried out.

In the method of producing of the present invention, although the mechanism of separating individual cup-shaped nanocarbon from the cup-stacked carbon nanotube is unknown, it is considered to be as follows. The main factor is considered to be an electrostatic repulsion of individual cup-shaped nanocarbon. In other words, by applying the reduction treatment to the cup-stacked carbon nanotube, individual cup-shaped nanocarbon that configures the carbon nanotube becomes a negatively-charged anionic molecule. It is estimated that those anionic molecules are separated due to the repulsion among negative charge thereof. Further, it is estimated that the obtained cup-shaped nanocarbon remains in an individually separated manner without reconstructing the cup-stacked carbon nanotube as long as it retains its anionic characteristic. Moreover, the cup-shaped nanocarbon having substituent hardly reconstructs the cup-stacked carbon nanotube. This will be explained later. However, these estimations do not limit the present invention,

### BRIEF DESCRIPTION OF DRAWINGS

FIG. 1 is a scheme describing an embodiment of the present invention.

FIG. 2 is a scanning electron micrograph. This micrograph shows a cup-stacked carbon nanotube after purification in Example.

FIG. 3 is a scanning electron micrograph. This micrograph shows a cup-shaped nanocarbon in Example.

FIG. 4 is a scanning electron micrograph. This micrograph shows a dodecylated cup-shaped nanocarbon in Example.

FIG. 5 is a transmission electron micrograph. This micrograph shows a cup-stacked carbon nanotube after purification in Example.

FIG. 6 is a transmission electron micrograph. This micrograph shows a cup-shaped nanocarbon in Example.

FIG. 7 is a transmission electron micrograph. This micrograph shows a dodecylated cup-shaped nanocarbon in Example.

FIG. 8 is a size distribution chart of a dynamic light scattering measurement. FIG. 8 (a) shows measurement result of a cup-stacked carbon nanotube after purification in Example. FIG. 8 (b) shows measurement result of a dodecylated cup-shaped nanocarbon in Example.

FIG. 9 is a scanning electron micrograph. This figure shows a cup-stacked carbon nanotube after purification in Example.

FIG. 10 is a scanning electron micrograph. This figure shows a cup-shaped nanocarbon in Example. This cup-shaped nanocarbon is a molecule obtained by reducing a cup-stacked carbon nanotube with a photoexcited nicotinamide dimer.

FIG. 11 is a transmission electron micrograph. This figure shows a cup-stacked carbon nanotube after purification in Example.

FIG. 12 is a transmission electron micrograph. This figure shows a cup-shaped nanocarbon in Example. This cup-shaped nanocarbon is a molecule obtained by reducing a cup-stacked carbon nanotube with a photoexcited nicotinamide dimer.

FIG. 13 is an ultraviolet-visible (UV-Vis) spectroscopic absorption spectrum. This figure shows spectrum that tracks reaction in which a cup-stacked carbon nanotube is reduced with photoexcited nicotinamide dimer in Example.

FIG. 14 is a transmission electron micrograph of the cup-stacked carbon nanotube used in Example. FIG. 14 (a) shows the cup-stacked carbon nanotube before centrifugal separation. FIG. 14 (b) shows the cup-stacked carbon nanotube after centrifugal separation.

FIG. 15 is a graph of an ultraviolet-visible-near-infrared (UV-Vis-NIR) spectroscopic absorption spectrum. In this figure, the curve (a) indicates an absorbance of a cup-stacked carbon nanotube used in Example. The curve (b) indicates an absorbance of a cup-shaped nanocarbon obtained in Example. The curve (c) indicates an absorbance of sodium naphthalenide serving as a reducing agent.

FIG. 16 is an ESR spectrum. FIG. 16 (a) shows result of a cup-stacked carbon nanotube used in Example. FIG. 16 (b) shows a spectrum of a cup-shaped nanocarbon anion.

FIG. 17 is an infrared (IR) spectrum. FIG. 17 (a) shows a spectrum of a cup-stacked carbon nanotube used in Example. FIG. 17 (b) shows a spectrum of a dodecylated cup-shaped nanocarbon obtained in Example

FIG. 18 is a transmission electron micrograph (TEM). This figure shows a dodecylated cup-shaped nanocarbon in Example.

FIG. 19 (a) is a photograph of THF suspension of a cup-stacked carbon nanotube used in Example, showing a state of right after preparation and after standing for one hour. FIG. 19 (b) is a photograph of THF suspension of a dodecylated cup-shaped nanocarbon in Example, showing a state of right after preparation and after standing for one day.

FIG. 20 is an ultraviolet-visible (UV-Vis) spectroscopic absorption spectrum. This figure shows a spectrum that tracks reaction in which a cup-stacked carbon nanotube is reduced with photoexcited nicotinamide dimer in Example.

FIG. 21 is an ultraviolet-visible (UV-Vis) spectroscopic absorption spectrum. This figure shows a spectrum that tracks reaction in which a cup-stacked carbon nanotube is reduced with photoexcited nicotinamide dimer in Example.

FIG. 22 is a scheme describing an embodiment of the present invention.

FIG. 23 is an ESR spectrum of a cup-shaped nanocarbon anion.

FIG. 24 is a scanning electron micrograph. FIG. 24 (a) shows a cup-stacked carbon nanotube after purification in Example. FIG. 24 (b) shows a cup-shaped nanocarbon in Example. This cup-shaped nanocarbon is a molecule obtained by reducing a cup-stacked carbon nanotube with a photoexcited nicotinamide dimer.

FIG. 25 is a transmission electron micrograph. FIG. 25 (a) shows a cup-stacked carbon nanotube after purification in Example. FIG. 25 (b) shows a cup-shaped nanocarbon in Example. This cup-shaped nanocarbon is a molecule obtained by reducing a cup-stacked carbon nanotube with a photoexcited nicotinamide dimer.

FIG. 26 is a size distribution chart of a dynamic light scattering measurement. In this figure, “a” indicates measurement result of a cup-stacked carbon nanotube after purification in Example, and “b” and “c” indicate measurement results after reducing the cup-stacked carbon nanotube with a photoexcited nicotinamide dimer.

FIG. 27 is a size distribution chart of a dynamic light scattering measurement. In this figure, “a” indicates measurement result of a cup-shaped nanocarbon anion in deaerated acetonitrile, and “b” indicates measurement result of the same cup-shaped nanocarbon anion measured after dissolving in oxygen-saturated acetonitrile.

FIG. 28 is a schematic view showing an example of a form of a cup-shaped nanocarbon. FIG. 28 (a) is a side view. FIG. 28 (b) is a perspective view.

FIG. 29 is a perspective view showing an example of a cup-stacked carbon nanotube.

### BEST MODE FOR CARRYING OUT THE INVENTION

Hereinafter, the present invention is explained in details.

### <Cup-Stacked Carbon Nanotube and Cup-Shaped Nanocarbon>

In the present invention, a cup-stacked carbon nanotube is not limited. The cup-stacked carbon nanotube has a structure in which more than one cup-shaped nanocarbons are laminated in the height direction of a cup.

For example, the cup-shaped nanocarbon is formed of graphene sheets, and an upper portion of the cup and a bottom portion of the cup of the cup-shaped nanocarbon are opened. The inner diameter and the external diameter of the cup-shaped nanocarbon continuously increase from the bottom portion of the cup toward the upper portion of the cup. The cup-shaped nanocarbon has a hollow shape. Therefore, it can be said that the cup-shaped nanocarbon is like a hollow cylinder having openings at the bottom portion and upper portion. Further, since the cup-shaped nanocarbon is a building block of the cup-stacked carbon nanotube, it can be considered as a nanocarbon tubular unit. Moreover, since the cup-shaped nanocarbon is a kind of a molecule having large molecular weight, it can be considered as a cup-shaped nanocarbon molecule. The upper portion and the bottom portion may be totally opened. Further, the upper portion and the bottom portion may be partially opened. For example, the sectional side of the cup-shaped nanocarbon has a taper shape. Specifically, as described above, the inner diameter and the external diameter of the cup-shaped nanocarbon are continuously increased from the bottom portion of the cup toward the upper portion of the cup. Examples of the shape of the bottom portion and the upper portion include circle, approximate circle, ellipse, etc.

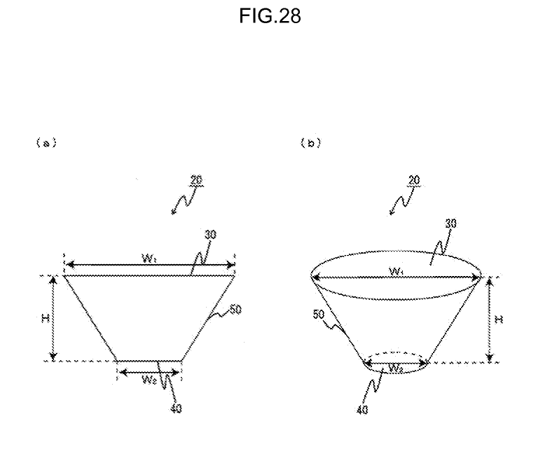

An example of the form of the cup-shaped nanocarbon is shown in FIG. 28. FIG. 28 is a schematic view showing an example of the cup-shaped nanocarbon. FIG. 28 (a) is a side view of the cup-shaped nanocarbon. FIG. 28 (b) is a perspective view of the cup-shaped nanocarbon. As shown in FIG. 28, a cup-shaped nanocarbon 20 includes a circular upper portion 30, a circular bottom portion 40, and a side surface 50. The cup-shaped nanocarbon 20 has a hollow body opened at the upper portion 30 and the bottom portion 40. The cross section of the side surface 50 is a taper shape. Specifically, the side surface 50 has a shape continuously spreading from the bottom portion 40 to the upper portion 30. In other words, the inner diameter and the external diameter of the cup-shaped nanocarbon 20 are increased continuously from the bottom portion 40 to the upper portion 30. In FIG. 28, W₁ indicates the bore diameter of an opening of the upper portion 30, W₂ indicates the bore diameter of an opening of the bottom portion 40, and H indicates the length between a center of the bottom portion 40 and a center of the upper portion 30. Hereinafter, this length is also referred to as a height of the cup-shaped nanocarbon.

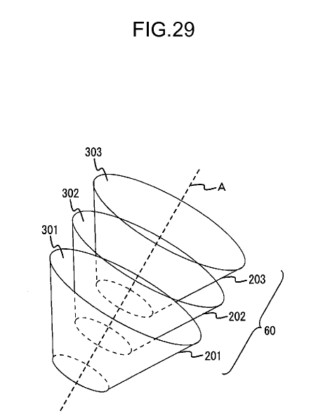

However, FIG. 28 and its explanation are merely examples and the present invention is not limited thereto. Further, FIG. 28 is a mere schematic view and it is not limited to expressions of a straight line, a curved line, and a solid line. For example, the ratio between the bore diameter of the opening of the upper portion 30 and the bore diameter of the opening of the bottom portion 40 is not limited. In other words, the bore diameter of the upper portion 30 may be larger than that of the bottom portion 40 or smaller than that of the bottom portion 40. In FIG. 28, although the ridge line between the upper portion 30 and the bottom portion 40 is a straight line, it may be a curved line. The form of the cup-shaped nanocarbon of the present invention is not limited as long as it is not departed from the scope of the present invention. The same can be said with respect to FIG. 29 described later.

In the present invention the size of the cup-shaped nanocarbon is not limited. The bore diameter of the upper portion is not limited and is, for example, in the range of 1 to 1500 nm, preferably in the range of 1 nm to 1000 nm, and more preferably in the range of 10 nm to 100 nm. The bore diameter of the upper portion is further preferably in the range of 10 nm to 50 nm. In a case where the shape of the opening of the upper portion is a perfect circle, the bore diameter means normally a diameter. Further, in a case where the shape of the opening of the upper portion is a circle other than a perfect circle such as an ellipse, the bore diameter means a major axis. The same can be said with respect to the opening of the bottom portion. Hereinafter, in the present invention, the bore diameter of the cup-shaped nanocarbon indicates the bore diameter of the opening of the upper portion.

The bore diameter of the opening of the bottom portion of the cup-shaped nanocarbon is not limited. In the present invention, the opening of the upper portion is preferably larger than the opening of the bottom portion. The ratio between an area of the opening of the upper portion (A) and an area of the opening of the bottom portion (B) is not limited. A:B is, for example in the range of 1000:1 to 100:1, preferably in the range of 100:1 to 10:1, and more preferably in the range of 10:1 to 1.1:1. The bore diameter of the opening of the bottom portion is, for example, in the range of 1 to 100 nm, preferably in the range of 10 to 80 nm, and more preferably in the range of 30 to 60 nm. In a case where the opening of the bottom portion is a perfect circle, the bore diameter means normally a diameter.

The length between the bottom portion and the upper portion, i.e., the height of the cup-shaped nanocarbon is, for example, in the range of about 10 to 500 nm. The height is preferably in the range of 10 to 100 nm and more preferably in the range of 10 to 50 nm.

In a case where the scope of the invention is defined by a numeric value, the present invention includes not only a strict numeric value range but also an approximate numeric value range. For example, the expression “in the range of 10 nm to 100 nm” includes a strict numeric value range of 10 nm to 100 nm and an approximate numeric value range of about 10 nm to about 100 nm. Hereinafter, the same applies.

The cup-shaped nanocarbon is normally formed of graphene sheets. The meaning of the term “graphene sheet” is clearly known to those skilled in the art. Hereinafter, an example of the configuration of the graphene sheet is explained. However, the present invention is not limited thereto.

The graphene sheet is a sheet-like molecule formed by covalent bonding of a number of carbons. Each carbon atom forms polygon (many-membered ring) such as a hexagon (six-membered ring) by covalent bonding. The many-membered rings are reticulated to configure the graphene sheet. Theoretically, a graphene sheet composed only of the six-membered ring has a perfect flat surface. In a case where a graphene sheet contains other many-membered rings such as five-membered ring, seven-membered ring, and eight-membered ring, the sheet has a rough surface due to generation of distortion at the portion of the other polygon. In the graphene sheet, it is preferable that more than 90% of carbon atoms form the six-membered ring. It is more preferable that more than 95% of carbon atoms form the six-membered ring. Normally, the carbon atom that forms the graphene sheet is sp² hybrid carbon atom. For example, the carbon atom may include sp³ hybrid carbon atom and sp hybrid carbon atom.

In the present invention, the cup-shaped nanocarbon may be formed only of carbon. Further, the cup-shaped nanocarbon may further contain other atom. Examples of other atom include hydrogen atom, heteroatom, etc. The same can be said with respect to the cup-stacked carbon nanotube configured by this cup-shaped nanocarbon.

The cup-stacked carbon nanotube is configured by laminating more than one cup-shaped nanocarbon described above in the height direction of the cup.

An example of the form of the cup-stacked carbon nanotube is shown in FIG. 29. FIG. 29 is a perspective view of the cup-stacked carbon nanotube. As shown in FIG. 29, in a cup-stacked carbon nanotube 60, plural cup-shaped nanocarbons 201, 202, and 203 are laminated in the height direction of the cup. In FIG. 29, a dashed line A indicates a height direction of each cup-shaped nanocarbon 20. Specifically, with respect neighboring to two cup-shaped nanocarbons (201 and 202), a bottom portion of the cup of one cup-shaped nanocarbon 202 is inserted into an upper portion opening 301 of the cup of the other cup-shaped nanocarbon 201. Further, with respect to two neighboring cup-shaped nanocarbons (202 and 203), a bottom portion of the cup of one cup-shaped nanocarbon 203 is inserted into an upper portion opening 302 of the cup of the other cup-shaped nanocarbon 202. In this manner, the cup-stacked carbon nanotube is formed by laminating plural cup-shaped nanocarbons in the height direction of the cup. Further, the bottom portion inserted into the inside of the other cup-shaped nanocarbon is surrounded with the other cup-shaped nanocarbon and is not exposed outwardly. However, FIG. 29 and its explanation are mere examples and the present invention is not limited thereto. Further, FIG. 29 is a mere schematic view and the present invention is not limited to expressions of a straight line, a curved line, and a solid line, and the number of the cup-shaped nanocarbon.

In the present invention, the size of the cup-stacked carbon nanotube is not limited. The number of lamination of the cup-shaped nanocarbon configuring the cup-stacked carbon nanotube is not limited. The number of lamination is, for example, from several to several hundred. Specifically, the number of lamination is preferably in the range of 2 to 100000 and more preferably in the range of 2 to 1000. The length of the cup-stacked carbon nanotube is not limited. The length is, for example, in the range of 50 nm to 100 μm, preferably in the range of 50 nm to 50 μm, and more preferably in the range of 50 nm to 10 μm. The cup-stacked carbon nanotube has a fibrous form, for example. The bore diameter of the cup-stacked carbon nanotube is not limited. The bore diameter of the cup-stacked carbon nanotube is normally a maximum diameter of a surface perpendicular to the height direction in the whole cup-stacked carbon nanotube. In other words, in FIG. 29, the bore diameter of the upper portion opening of the cup-shaped nanocarbon configuring the cup-stacked carbon nanotube is normally the bore diameter of the carbon nanotube. The bore diameter is, for example, in the range of 1 to 10000 nm. The bore diameter is preferably in the range of 1 nm to 1000 nm, and more preferably in the range of 10 nm to 100 nm.

### <Method of Producing Cup-Shaped Nanocarbon>

A method of producing a cup-shaped nanocarbon of the present invention can be carried out as follows, for example. As described above, this method is a method of separating individual cup-shaped nanocarbon from the cup-stacked carbon nanotube. However, the present invention is not limited to the following explanation.

First, as the process (A), a material containing the cup-stacked carbon nanotube is prepared. This process is not limited, however and is, for example, as follows.

As described above, the cup-stacked carbon nanotube used for the present invention is not limited. For example, a commercially available cup-stacked carbon nanotube can be used. The commercially available cup-stacked carbon nanotube can be obtained from GSI Creos Corporation (Chiyoda-ku Tokyo, Japan). An example of the available product includes Carbere®. Further, a cup-stacked carbon nanotube may be prepared. A person skilled in the art of the present invention can produce a cup-stacked carbon nanotube on the basis of the description of the present invention and the technical common knowledge without conducting excessive trial and complicated and sophisticated examination. The method of producing the cup-stacked carbon nanotube is reported in Endo, M et al., Appl. Phys. Lett. 2002, 80, 1267, for example.

The commercially available or the self prepared cup-stacked carbon nanotube can be used directly. Preferably, the commercially available or the self prepared cup-stacked carbon nanotube is subjected to a purification treatment as required in advance of separation into a cup-shaped nanocarbon. The purification treatment makes it possible to remove impurities mixed in the material that contains the cup-stacked carbon nanotube. A method of purification is not limited and an example thereof includes a method described in J. Phys. Chem. B 2001, 105, 8297. In this method, the cup-stacked carbon nanotube is heated at 225° C. to 425° C. for several hours in a mixed gas of Ar and O₂. Thereafter, the cup-stacked carbon nanotube is subjected to an ultrasonic cleaning with a high concentration acridinium hydrochloride. This heating treatment and ultrasonic cleaning with hydrochloric acid are repeated for several times. Thereby, impurities such as metal catalyst can be removed.

In the present invention, size, form, structure, etc. of the cup-stacked carbon nanotube are not limited and are as described above. Size, form; structure, etc. of the cup-shaped nanocarbon configuring the cup-stacked carbon nanotube are also not limited and are as described above. It is preferable that the cup-stacked carbon nanotube is formed of the cup-shaped nanocarbons having the same size and form or having approximately the same size and form. When individual cup-shaped nanocarbon is separated from such cup-stacked carbon nanotube, the cup-shaped nanocarbon having approximately uniform size and form can be obtained. Generally, the cup-stacked carbon nanotube is formed of the cup-shaped nanocarbon having the same size and form or having approximately the same size and form.

For Example, the cup-stacked carbon nanotube contained in the material may be separated according to the size thereof. In this manner, when the cup-stacked carbon nanotube is fractionated according to the size thereof, it is easier to obtain the cup-shaped nanocarbon with approximately uniform size.

The size to be considered in the fractionation is, for example, the bore diameter of the cup-stacked carbon nanotube. For example, the cup-stacked carbon nanotube having the bore diameter not less than a certain level may be removed from the mixture of the cup-stacked carbon nanotubes having the bore diameter of different sizes. The size of the bore diameter of the cup-shaped nanocarbon is preferably in the aforementioned range. Therefore, it is preferable that the cup-stacked carbon nanotubes having the bore diameter of more than 1000 nm are removed. More preferably, the cup-stacked carbon nanotubes having the bore diameter of more than 100 nm are removed. Further preferably, the cup-stacked carbon nanotubes having the bore diameter of more than 50 nm are removed.

A method of removing is not limited. For example, first, the mixture of the cup-stacked carbon nanotubes is suspended in solvent. This solvent is not limited and examples thereof include halogenated solvent, ether, etc. Examples of the halogenated solvent include chloroform, methylene chloride. Examples of the ether include diethyl ether, tetrahydrofuran (THF), etc. One of those solvents may be used alone or two or more of them may be used in combination. Next, the suspension is separated by centrifugal separation into sediment and supernatant solution. Conditions of the centrifugal separation are not limited. The supernatant solution is filtrated with a filter. Use of the filter with the desired pore diameter makes it possible to fractionate the cup-stacked carbon nanotube. The pore diameter of the filter can be decided suitably according to the bore diameter of the cup-stacked carbon nanotube desired to be removed. The obtained filtrate may be concentrated. In this manner, the cup-stacked carbon nanotube can be fractionated according to the bore diameter thereof.

Next, as the process (B), the cup-stacked carbon nanotube is subjected to a reduction treatment. Thereby, individual cup-shaped nanocarbon can be separated from the cup-stacked carbon nanotube. In the present invention, with respect to separation of the cup-shaped nanocarbon, all cup-shaped nanocarbons configuring the cup-stacked carbon nanotube may be separated. Further, some (one or more than one) cup-shaped nanocarbons may be separated and remnant cup-shaped nanocarbons may be left in a laminated state. In the process (B), the reduction treatment technique is not limited as long as the cup-stacked carbon nanotube can be reduced.

The reducing agent is not limited. With respect to the reducing agent, it is preferable that a redox potential thereof is −0.5V or less with an electric potential of saturated calomel electrode being considered as the standard (0V). The redox potential is an index indicating the strength of oxidative power or reducing power. When the value of the redox potential of the reducing agent is relatively small, the reducing power of the reducing agent is relatively strong. The redox potential can be measured by the following method. First, 0.05 to 0.5 mol of the reducing agent and 0.0002 mol of electrolyte, hexafluoride phosphate tetra-n-butylammonium, are dissolved in 2 mL of tetrahydrofuran. With respect to this mixture, the redox potential is measured at 25° C. with platinum electrode or gold electrode being considered as working electrode and platinum being considered as counter electrode. This measurement method is a method for identifying the redox potential of the reducing agent, and does not limit the present invention at all. The redox potential of the reducing agent is preferably −0.6 V or less with the electric potential of saturated calomel electrode being considered as the standard (0 V). More preferably, the redox potential of the reducing agent is −1 V or less with the electric potential of saturated calomel electrode being considered as the standard (0 V). Further preferably, the redox potential of the reducing agent is −1.5 V or less with the electric potential of saturated calomel electrode being considered as the standard (0 V). Particularly preferably, the redox potential of the reducing agent is −2 V or less with the electric potential of saturated calomel electrode being considered as the standard (0 V).

The reducing agent includes a specific redox potential. A person skilled in the art of the present invention can decide the redox potential of various reducing agents. Therefore, a person skilled in the art can select the reducing agent indicating the desired redox potential without conducting excessive trial and complicated and sophisticated examination.

The reducing agent may be an inorganic reducing agent or an organic reducing agent. Examples of the inorganic reducing agent include alkali metal, hydride complex, etc. The reducing agent is preferably the organic reducing agent from a view point of solubility in an organic solvent and suppression of side-effects, etc.

For example, the organic reducing agent is preferably aromatic anion. Examples of the aromatic anion include bicyclic condensed carbon ring alkali metal salt, tricyclic condensed carbon ring alkali metal salt, etc. Examples of the bicyclic condensed carbon ring alkali metal salt include alkali metal naphthalenide having substituent, alkali metal naphthalenide having no substituent, etc. The alkali metal naphthalenide is easily dissolved in the organic solvent. Therefore, it is preferable from a view point of reaction efficiency, etc. Examples of the alkali metal include lithium, sodium, potassium, rubidium, cesium, etc. Among them, lithium, sodium, and potassium are preferable. As the alkali metal naphthalenide, sodium naphthalenide is particularly preferable. One of the organic reducing agents may be used alone or two or more of them may be used in combination.

Further, the organic reducing agent is preferably at least one of photoexcited active specie of dihydropyridine dimer having substituent and photoexcitation active specie of dihydropyridine dimer having no substituent. For example, the dihydropyridine dimer is dihydronicotinamide dimer. Among them, photoexcited active specie of 1,1′-dibenzyl-3,3′-dicarbamoyl-1,1′,4,4′-tetrahydro-4,4′-bipyridine, i.e., photoexcited active specie of 1-benzyl-1,4-dihydronicotinamide dimer (BNA₂) is particularly preferable. The excitation light is not limited. For example, 1-benzyl-1,4-dihydronicotinamide dimer shows the peak at the wavelength of about 350 nm with a visible absorption spectrum. Therefore, it is preferable that the dimer is photoexcited by irradiating light comprising the wavelength of this peak.

Specifically, when 1-benzyl-1,4-dihydronicotinamide dimer is photoexcited, the redox potential thereof becomes about −3.1 V relative to the saturated calomel electrode. Further, the sodium naphthalenide is as follows. Specifically, the redox potential of radical, in which naphthalene is reduced by one-electron, is about −2.5 V relative to the saturated calomel electrode. The sodium naphthalenide has larger redox potential than that of this radical, and the redox potential thereof is around −2 V relative to the saturated calomel electrode. In, this manner, these reducing agents have strong reducing power.

Other than this, specific examples of the organic reducing agent include anthracene radical anion, 10,10′-dimethyl-9,9′-biacridine, etc.

The reduction treatment normally is carried out in solvent. The solvent is not limited. The solvent is preferably organic solvent. The solvent may contain water. The organic solvent is preferably aprotic solvent from a view point of suppressing side-effects. Examples of the aprotic solvent include ether, halogenated solvent, aromatic hydrocarbon, aliphatic hydrocarbon, ketone, nitryl, amido, sulfoxide, etc. Examples of the ether include diethyl ether, tetrahydrofuran (THF), dioxane, dimethoxyethane (DME), etc. Examples of the halogenated solvent include dichloromethane, chloroform, chlorobenzene, etc. Examples of the aromatic hydrocarbon include benzene, toluene, etc. Examples of the aliphatic hydrocarbon include hexane, etc. Examples of the ketone include acetone, etc. Examples of the nitryl include acetonitrile, etc. Examples of the amido include dimethylformamide (DMF), dimethylacetamide, 1-methyl-2-pyrrolidone, etc. Examples of the sulfoxide include dimethyl sulfoxide (DMSO), etc. One of the organic solvents may be used alone or two or more of them may be used in combination.

It is preferable that the solvent does not contain water. Under such condition, inhibition of electron transfer from the reducing agent to the cup-shaped nanocarbon can be avoided sufficiently. The amount of water contained in the solvent is preferably 0.05% by volume or less. The amount of water is more preferably 0.005% by volume or less, and further preferably not more than the detection limit. It is preferable that the solvent is preliminarily dehydrated before use, for example.

The reduction treatment preferably is carried out under condition not containing oxygen. Under such condition, inhibition of electron transfer from the reducing agent to the cup-shaped nanocarbon can be avoided sufficiently. It is preferable that the solvent is preliminarily deaerated before use, for example.

The reduction treatment preferably is carried out in inert gas atmosphere, for example. An example of the inert gas includes rare gas. Examples of the rare gas include argon, krypton, xenon, etc. Besides the rare gas, examples of the inert gas include other gases not involving reaction. Examples of the other gas include nitrogen, etc. The inert gas atmosphere is not limited, however nitrogen atmosphere or argon atmosphere is preferable.

With respect to the process (B), a specific example of the reduction treatment using the reducing agent is as follow. However, the present invention is not limited thereto.

First, a reaction solution is prepared by dissolving or suspending a cup-stacked carbon nanotube into solvent. The amount of the cup-stacked carbon nanotube to be added in the reaction solution is, for example in the range of 1 to 20% by weight, preferably in the range of 1 to 10% by weight, and more preferably in the range of 1 to 2% by weight. Further, the amount of the reducing agent to be added in the reaction solution is, for example in the range of 1 to 20% by weight, preferably in the range of 1 to 10% by weight, and more preferably in the range of 1 to 2% by weight. The molar ratio (C:D) between carbon atom in the cup-stacked carbon nanotube (C) and the reducing agent (D) is not limited and is, for example, in the range of C:D=1:10 to 1:20. The molar ratio C:D is preferably in the range of C:D=1:10 to 1:15, and more preferably in the range of C:D=1:0 to 1:11. The reaction solution may contain other additives within a range in which the reaction between the cup-stacked carbon nanotube and the reducing agent is not obstructed.

Further, in this reaction solution, the cup-stacked carbon nanotube and the reducing agent are reacted. Conditions of the reaction are not particularly limited. The reaction temperature is, for example, in the range of 20 to 30° C. and preferably in the range of 20 to 25° C. The reaction time is, for example, in the range of 10 to 20 hours and preferably in the range of 10 to 15 hours. Further, when the reaction is carried out under the inert gas atmosphere, the ratio of the inert gas in the atmosphere is, for example, 99% by volume or more. The ratio is preferably 99.99% by volume.

In this manner, individually separated cup-shaped nanocarbon can be produced. The cup-shaped nanocarbon obtained by the present invention is presented in a stable manner. Therefore, reconstruction to the cup-stacked carbon nanotube less likely occurs. This may be because the cup-shaped nanocarbon configuring the cup-stacked carbon nanotube is separated as a negatively-charged anionic molecule by the reduction treatment. The anionic cup-shaped nanocarbon thus obtained is preferably handled under a condition of less oxygen and water. An example of such condition includes a dry inert gas atmosphere. Under such a condition, the stability of the anionic cup-shaped nanocarbon further reliably can be maintained.

The anionic molecule may be isolated from the reaction solution as a salt. This isolation process is not limited and a normal means such as filtration can be adopted.

### <Method of Producing Derivative of Cup-Shaped Nanocarbon>

A method of producing a cup-shaped nanocarbon of the present invention may further comprise the following process (C).

(C) a process of reacting the cup-shaped nanocarbon obtained in the process (B) with an electrophilic agent to introduce a substituent therein.

The introduction reaction of the substituent in the process (C) is normally estimated to be an electrophilic addition reaction, or the like. However, this estimation does not limit the present invention.

Technique of introducing the substituent by reacting the individually separated cup-shaped nanocarbon anion with the electrophilic agent in this manner was performed for the first time by the inventors of the present invention. Thereby, the further stable cup-shaped nanocarbon can be obtained. In other words, the reaction of the cup-shaped nanocarbon anion and the electrophilic agent makes it possible to form neutral molecule by neutralizing the negative charge. Therefore, alteration of the cup-shaped nanocarbon due to oxygen and water, etc. can be prevented sufficiently. The derivative to which the substituent is introduced further reliably can maintain a separated state of individual molecule. It is considered that this may be because of the steric bulk of the substituent. Specifically, even when the individually separated cup-shaped nanocarbons try to go back to a state of lamination due to intermolecular force, this may be prevented by the steric bulk of the substituent. However, this estimation does not limit the present invention.

The electrophilic agent is not limited. The various electrophilic agents can be selected suitably according to the desired substituent to be introduced.

An example of the electrophilic agent includes a compound represented by the following chemical formula (1). In the formula (1), R represents hydrogen atom, straight chain or branched alkyl group. The straight chain or branched alkyl group may include or may not include a substituent. The alkyl group may be interrupted or may not be interrupted by at least one of an oxy group (—O—) and an amido group (—CONH—). X represents an elimination group. Such electrophilic agent introduces the substituent R—CH₂— to the cup-shaped nanocarbon.

R—CH₂—X (1)

The carbon number of the straight chain alkyl group is preferably in the range of 1 to 30 and more preferably in the range of 5 to 20. The carbon number of the branched alkyl group is preferably in the range of 1 to 30 and more preferably in the range of 5 to 20. The elimination group X is not limited. Examples of X include elimination groups publicly known as the elimination group in the electrophilic addition reaction. Preferable examples of X include halogen, a methylsulfonyl group (CH₃SO₂—), a trifluoromethylsulfonyl group (CF₃SO₂—), and a chloromethylsulfonyl group (ClCH₂SO₂—). As for X, bromine or iodine is particularly preferable.

Examples of the halogen include fluorine, chlorine, bromine, iodine, etc. The alkyl group is not limited. Examples of the alkyl group include a methyl group, an ethyl group, an n-propyl group, an isopropyl group, an n-butyl group, an isobutyl group, a sec-butyl group, a tert-butyl group, etc. The same applies to a group containing an alkyl group in its structure and a group induced from an alkyl group. Examples of such group include an alkylsulfonyl group, a halogenated alkyl group, etc.

In a case where the straight chain or branched alkyl group includes a substituent, the substituent is not limited. For example, the substituent is preferably a substituent not inhibiting the electrophilic reaction. An example of the substituent includes a trimethylsilyloxy group expressed by

(CH₃)₃Si—O—.

The reaction condition in this substituent introduction treatment is not limited. An example of the reaction condition is described as follows. However, the present invention is not limited thereto.

For example, the cup-shaped nanocarbon anion obtained in the process (B) can directly be used. Further, for example, from a view point of suppressing side-effects, etc., the cup-shaped nanocarbon may be isolated from the reaction solution of the process (B) as a salt, and the salt thus obtained may be used.

The substituent introduction treatment can be carried out under the similar condition to the aforementioned reduction treatment. Specifically, this treatment preferably is carried out under a condition of less oxygen and water. In such environment, for example, inhibition of substituent introduction reaction can be avoided sufficiently. This substituent introduction process is preferably carried out in inert gas atmosphere as in the case of the reduction treatment. The inert gas atmosphere is, for example, as described above, and nitrogen atmosphere or argon atmosphere is preferable.

The substituent introduction treatment normally is carried out in solvent. The condition of this solvent is similar to that of the reduction treatment. Therefore, it is preferable that this solvent is preliminarily dehydrated before use. Further, it is preferable that this solvent is preliminarily deaerated before use, for example.

Specific example of the substituent introduction treatment in the process (C) is described below. However, the present invention is not limited thereto.

First, a reaction solution is prepared by dissolving or suspending a cup-shaped nanocarbon and the electrophilic agent into solvent. The amount of the cup-shaped nanocarbon to be added in the reaction solution is, for example in the range of 0.6 to 0.9% by weight, preferably in the range of 0.6 to 0.8% by weight, and more preferably in the range of 0.6 to 0.7% by weight. Further, the amount of the electrophilic agent to be added in the reaction solution is, for example in the range of 25 to 35% by volume, preferably in the range of 25 to 30% by volume, and more preferably in the range of 29 to 30% by volume. The molar ratio (E:F) between carbon atom in the cup-shaped nanocarbon (E) and the electrophilic agent (F) is not limited and is, for example, in the range of E:F=1:10 to 1:20. The molar ratio E:F is preferably in the range of E:F=1:10 to 1:15, and more preferably in the range of E:F=1:10 to 1:11. The reaction solution may contain other additives within a range in which the reaction between the cup-shaped nanocarbon and the electrophilic agent is not obstructed.

Further, in this reaction solution, the cup-shaped nanocarbon and the electrophilic agent are reacted. Conditions of the reaction are not particularly limited. The reaction temperature is, for example, in the range of 20 to 30° C. and preferably in the range of 20 to 25° C. The reaction time is, for example, in the range of 10 to 24 hours and preferably in the range of 10 to 15 hours. Further, when the reaction is carried out under the inert gas atmosphere, the ratio of the inert gas in the atmosphere is, for example, 99% by volume or more. The ratio is preferably 99.99% by volume.

In this manner the derivative to which the substituent is introduced can be obtained. The derivative thus obtained can be isolated by filtration or the like.

### <Cup-Shaped Nanocarbon of the Present Invention>

As described above, the cup-shaped nanocarbon of the present invention is a negatively-charged anionic molecule. The cup-shaped nanocarbon of the present invention can be produced by the method of producing a cup-shaped nanocarbon of the present invention described above. However, the present invention is not limited to this method. The form and size of the cup-shaped nanocarbon of the present invention are as described above unless otherwise described.

Further, the cup-shaped nanocarbon of the present invention is preferably a derivative having substituent (hereinafter, also referred to as “derivative”). The substituent in the derivative is not limited. An example of the substituent includes a substituent represented by the following chemical formula (2). The derivative to which such substituent is introduced can be produced by using the electrophilic agent represented by the chemical formula (1) in the method of producing the cup-shaped nanocarbon of the present invention. However, the present invention is not limited to this method. In the chemical formula (2), R is same as that of the case of the chemical formula (1).

R—CH₂— (2)

With respect to the cup-shaped nanocarbon of the present invention, for example, a negatively-charged anionic molecule is useful as a material of the derivative having the substituent. An example of other usage includes an electrode material of secondary cell (lithium-ion cell), for example. The derivative having the substituent enables the development of various capabilities suitably according to, for example, characteristics of the substituent. Therefore, the derivative having the substituent is expected to be applied to various usages. Specifically, the derivative having the substituent is expected as an additive to an electrolyte used for a dye-sensitized solar cell, and an electrode of a fuel cell. Further, examples of possible usage include, as same as the conventional carbon nanotube, functional materials such as molecular device capable of ultra high integration, storage materials for various gasses such as hydrogen, field emission display (FED) members, electronic materials, electrode materials, additives for resin molding, etc.

### EXAMPLES

Examples of the present invention are explained as follows. However, the present invention is not limited thereto.

### <Measuring Instrument, Etc.>

As for a scanning electron microscope, JSM-6700 (trade name) manufactured by JEOL Ltd. was used. As for a transmission electron microscope, H-800 (trade name) manufactured by Hitachi, Ltd. was used. As for an ultraviolet-visible-near-infrared (UV-Vis-NIR) spectroscopic absorption spectrum or an ultraviolet-visible spectroscopic absorption spectrum (UV spectrum), a spectrophotometer (trade name: UV-3100PC) manufactured by Shimadzu Corporation or a photodiode array spectrophotometer (trade name: 8452A) manufactured by Hewlett-packard company was used. An ESR spectrum was measured using an X-band spectrometer (trade name: JES-RE1XE) manufactured by JEOL Ltd. in a quartz ESR tube (inner diameter: 4.5 mm). Elemental analysis was carried out with CHN-Corder (MT-2 type) (trade name) manufactured by Yanagimoto Mgf. Co., Ltd. All chemicals except for the cup-stacked carbon nanotube were reagent grade. The chemicals were bought from Nakarai Tesque, Inc. and Wako Pure Chemical, Ltd.

### <Preparation of Cup-Stacked Carbon Nanotube>

As for a cup-stacked carbon nanotube, a product manufactured by GSI Creos Corporation (Chiyoda-ku Tokyo, Japan) was used. This cup-stacked carbon nanotube is same as the product marketed by GSI Creos Corporation under the name of Carbere (trade name).

The cup-stacked carbon nanotube was purified according to a method described in J. Phys. Chem. B 2001, 105, 8297. More specifically, the cup-stacked carbon nanotube was treated according to the following procedures (i) to (v).
(i) the cup-stacked carbon nanotube was heated in Ar/O₂ mixed gas atmosphere at 225° C. for 18 hours. The mixture ratio (volume ratio) between Ar and O₂ was 80:20.
(ii) the cup-stacked carbon nanotube thus heated was cooled to room temperature. This was suspended in concentrated hydrochloric acid of 12 normal (12 mol/L) and subjected to an ultrasonic treatment for not less than 15 minutes.
(iii) the cup-stacked carbon nanotube subjected to the ultrasonic treatment was filtrated with a polytetrafluoroethylene membrane (manufactured by ADVANTEC) having the pore diameter of 1.0 μm. Filtrated solid was washed with deionized water and methanol for several times. Thereafter, the solid was dried under reduced pressure at 100° C. for 2 hours.
(iv) thus obtained dry substance of the cup-stacked carbon nanotube was heated in the same manner as process (i). The heating temperature was 325° C. and the heating time was 1.5 hours. Thereafter, the cup-stacked carbon nanotube repeatedly was subjected to the same treatment as the processes (ii) and (iii).
(v) the cup-stacked carbon nanotube after process (iv) was heated in the same manner as process (i). The heating temperature was 425° C. and the heating time was 1.0 hours. Thereafter, the cup-stacked carbon nanotube repeatedly was subjected to the same treatment as the processes (ii) and (iii).

The cup-stacked carbon nanotube purified according to the procedures (i) to (v) was treated with the following method. Thereby, cup-stacked carbon nanotubes, the bore diameter thereof is more than about 50 nm, were removed.

First, the purified cup-stacked carbon nanotube was added to chloroform (10 ml) so that the concentration thereof becomes 5 mg/ml. This mixture was irradiated with ultrasonic waves at 70 watt for 15 minutes to suspend the cup-stacked carbon nanotube. This suspension was applied with a centrifugal separation at 1880G (G: gravitational acceleration) for 15 minutes. Thus obtained supernatant solution was filtered with a polytetrafluoroethylene membrane having the pore diameter of 0.1 μm and filtrate was collected. This filtrate was the cup-stacked carbon nanotubes (object), the bore diameter thereof is not more than about 50 nm. This purified substance was used as the cup-stacked carbon nanotube in the following examples.

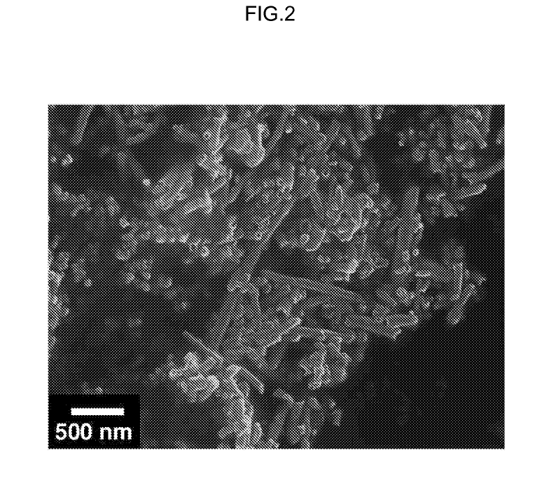

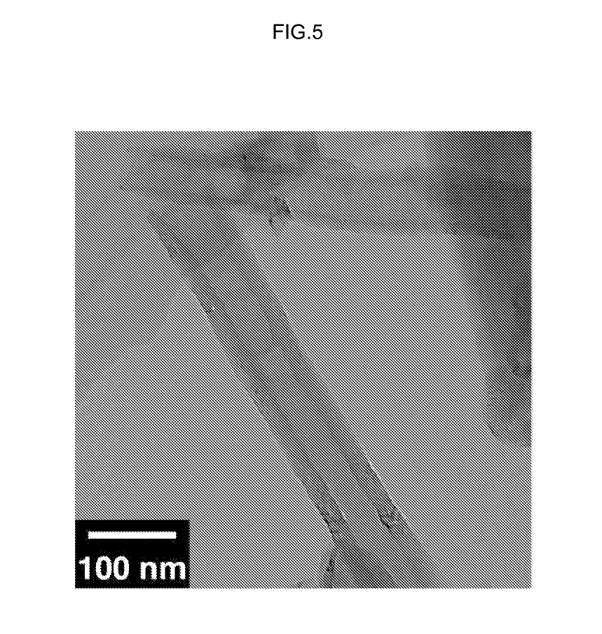

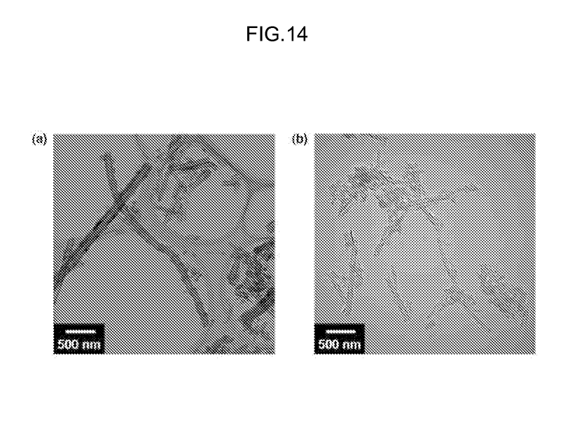

Transmission electron micrographs (TEM) of the cup-stacked carbon nanotube are shown in FIG. 14. FIG. 14 (a) is a micrograph of the cup-stacked carbon nanotube before centrifugal separation. FIG. 14 (b) is a micrograph of the cup-stacked carbon nanotube after the centrifugal separation. As shown in FIG. 14, the size (bore diameter) of each cup-stacked carbon nanotube was uneven before the centrifugal separation. In contrast, because of the centrifugal separation, the cup-stacked carbon nanotubes with approximately same bore diameter could be obtained. A scanning electron micrograph (SEM) of the cup-stacked carbon nanotube after the centrifugal separation is shown in FIG. 2. A transmission electron micrograph (TEM) of the cup-stacked carbon nanotube after the centrifugal separation is shown in FIG. 5. The micrograph of FIG. 5 was taken by changing the magnification from FIG. 14(b). The transmission electron micrograph was taken by applying acceleration voltage of 200 kilovolt. From these micrographs, the configuration of the cup-stacked carbon nanotube was confirmed.

### <Preparation of Reducing Agent Sodium Naphthalenide>

THF was distilled, dehydrated, and deaerated. Naphthalene was purified by sublimation. An argon atmosphere was prepared in a glove box. Under this argon atmosphere, dry THF solution (5 ml) was prepared that contains 0.05 g (0.39 mmol) of the purified naphthalene. Into this solution, 0.075 g (3.26 mmol) of washed metallic sodium was added and sodium naphthalenide solution was thus prepared.

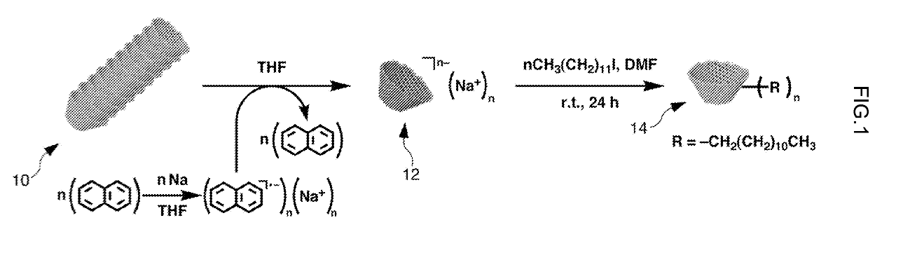

A scheme from the preparation of the sodium naphthalenide to Example 1 (production of cup-shaped nanocarbon anion) and Example 2 (production of cup-shaped nanocarbon derivative) is shown in FIG. 1. In FIG. 1, the numeric symbol 10 indicates a cup-stacked carbon nanotube, the numeric symbol 12 indicates a cup-shaped nanocarbon anion, and the numeric symbol 14 indicates a dodecylated cup-shaped nanocarbon. As shown in FIG. 1, naphthalene is reduced in the THF by metallic sodium and sodium naphthalenide is generated. Then, in the THF, the cup-stacked carbon nanotube 10 is reduced by the sodium naphthalenide. This reduction reaction generates a sodium salt of individually separated cup-shaped nanocarbon anion 12. Further, the cup-shaped nanocarbon anion 12 is reacted with 1-iodo n-dodecane to generate the dodecylated cup-shaped nanocarbon 14. FIG. 1 is a schematic view illustrating a possible mechanism. FIG. 1 and its explanation do not limit the reaction mechanism and product, etc. of Examples at all.

### Example 1

### Production of Cup-Shaped Nanocarbon Anion

Individual cup-shaped nanocarbon was separated from the cup-stacked carbon nanotube. Then, sodium salt of a cup-shaped nanocarbon anion was produced.

First, the sodium naphthalenide solution was added to the cup-stacked carbon nanotube (50 mg). A reduction reaction was carried out by stirring this mixture overnight under an argon atmosphere at room temperature. This reaction solution was filtered with a polytetrafluoroethylene membrane having the pore diameter of 0.1 μm. The filtered solid was repeatedly washed with distilled THF until it became colorless. The washed solid was dried by leaving it at rest at 100° C. for 24 hours in vacuum. In this manner, sodium salt of a cup-shaped nanocarbon anion was obtained.

Process of the reduction reaction was monitored by an ultraviolet-visible-near-infrared (UV-Vis-NIR) spectroscopic absorption spectrum measurement of the reaction solution. Naphthalene radical anion serving as the reducing agent has an absorption band at the wavelength of 500 to 900 nm. Therefore, the progress of the reduction reaction was confirmed by disappearance of the absorption band of the wavelength region. In this reduction reaction, the absorption band of the wavelength region was disappeared as the reaction was progressed. This meant that an electron transfer was carried out from a naphthalene radical anion of sodium naphthalenide to a cup-stacked carbon nanotube, and a cup-shaped nanocarbon anion was generated.

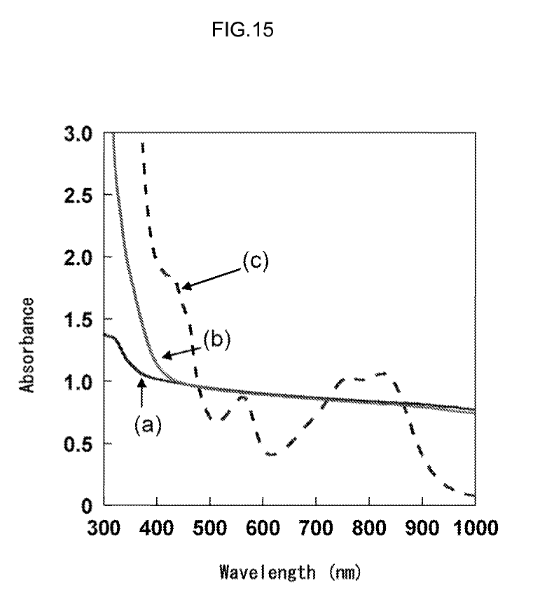

A graph of an ultraviolet-visible-near-infrared (UV-Vis-NIR) spectroscopic absorption spectrum is shown in FIG. 15. In FIG. 15, the curve (a) indicates an absorbance of the cup-stacked carbon nanotube. In FIG. 15, the curve (b) indicates an absorbance after reducing the cup-stacked carbon nanotube with sodium naphthalenide. In other words, the curve (b) indicates an absorbance of sodium salt of the cup-shaped nanocarbon. In FIG. 15, the curve (c) indicates an absorbance of sodium naphthalenide. As shown in FIG. 15, since sodium naphthalenide has the absorption band of 500 to 900 nm, the progress of the reaction can be confirmed by the disappearance thereof.

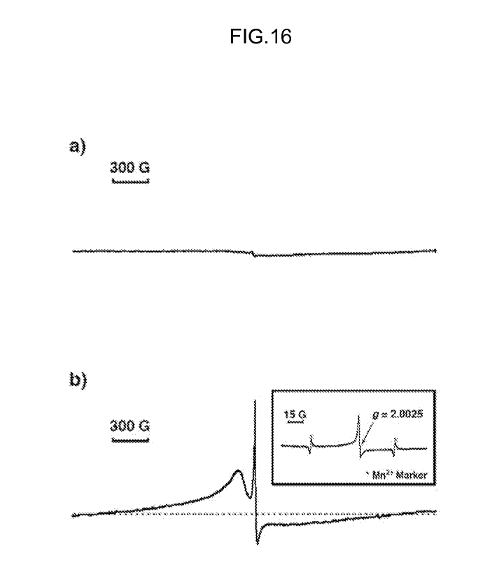

With respect to the cup-stacked carbon nanotube (0.023 g) and the sodium salt of the cup-shaped nanocarbon anion (0.015 g), an ESR spectrum was measured in the solid state. The measurement temperature was 298K (25° C.). The result of the ESR spectrum is shown in FIG. 16. FIG. 16 (a) is an ESR spectrum of the cup-stacked carbon nanotube. FIG. 16 (b) is an ESR spectrum of the sodium salt of the cup-shaped nanocarbon anion. An insertion view of FIG. 16 (b) is a partial enlarged view of the spectrum of FIG. 16 (b). In an insertion view of FIG. 16 (b), * indicates the signal of Mn²⁺ marker. As shown in FIG. 16 (a), the cup-stacked carbon nanotube before the reduction reaction did not show the signal. In contrast, as shown in FIG. 16 (b), a reactant after the reduction reaction showed a sharp signal at a position of g=2.0025. The position of the signal of g=2.0025 is very near a signal position of graphite doped by potassium (g=2.0027). From this signal, generation of the cup-shaped nanocarbon radical anion was confirmed.

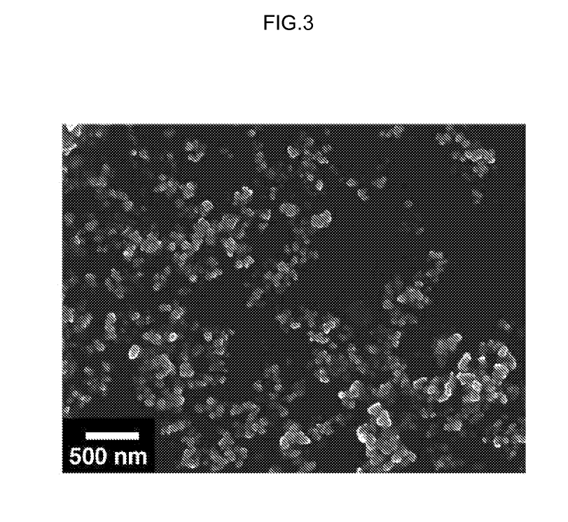

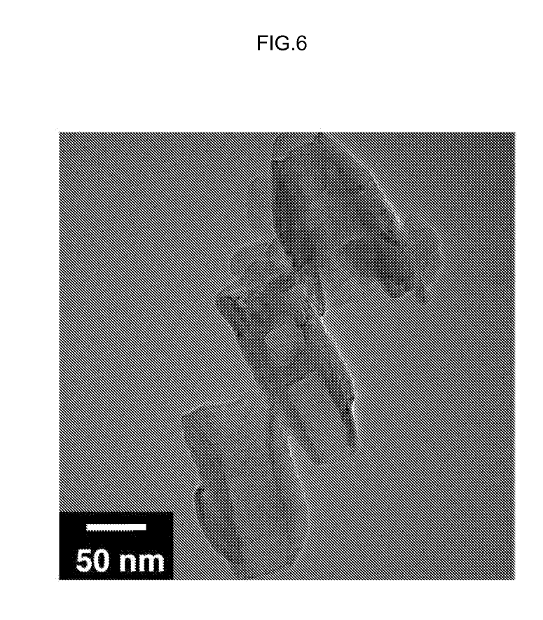

A scanning electron micrograph (SEM) is shown in FIG. 3. FIG. 3 is a micrograph of reactant after the reduction reaction. Further, a transmission electron micrograph (TEM) is shown in FIG. 6. FIG. 6 is a micrograph of reactant after the reduction reaction. The transmission electron micrograph was taken by applying acceleration voltage of 200 kilovolt. As compared to FIG. 2 showing a micrograph of the cup-stacked carbon nanotube, the reactant in FIG. 3 is degraded into small molecules. Further, as shown in FIG. 6, three individually separated cup-shaped nanocarbon were confirmed. From these results, it was found that the cup-shaped nanocarbon can separated individually by reducing the cup-stacked carbon nanotube. Further, as shown in FIG. 6, with respect to the cup-shaped nanocarbon, the length between a bottom surface and an upper surface is slightly larger than the bore diameter of the upper surface and the bottom surface.

### Example 2

### Production of Cup-Shaped Nanocarbon Derivative

A dodecylated cup-shaped nanocarbon, to which an n-dodecyl group was introduced, was produced. Hereinafter, it is referred to as a dodecylated derivative. First, a nitrogen atmosphere was prepared in a glove box. Under this nitrogen atmosphere, 1-iodo-n-dodecane (2 mL) and sodium salt of the cup-shaped nanocarbon anion produced in Example 1 (0.05 g) were mixed in deaerated DMF (5 mL). This mixture was stirred overnight at room temperature. Thus obtained suspension was filtrated with a polytetrafluoroethylene membrane having the pore diameter of 0.1 μm. The filtrated solid was washed with hexane and then washed with methanol. The washed solid was dried at room temperature. In this manner, a dodecylated derivative to which an n-dodecyl group was introduced was obtained.

(1) Confirmation of Form

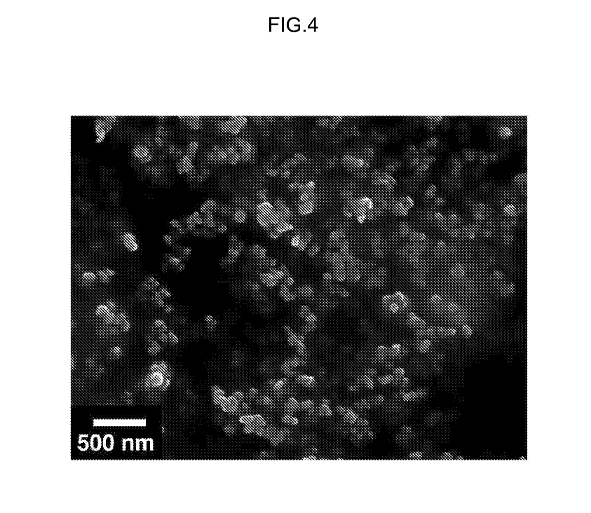

A scanning electron micrograph (SEM) is shown in FIG. 4. FIG. 4 is a micrograph of a dodecylated derivative obtained in Example 2.

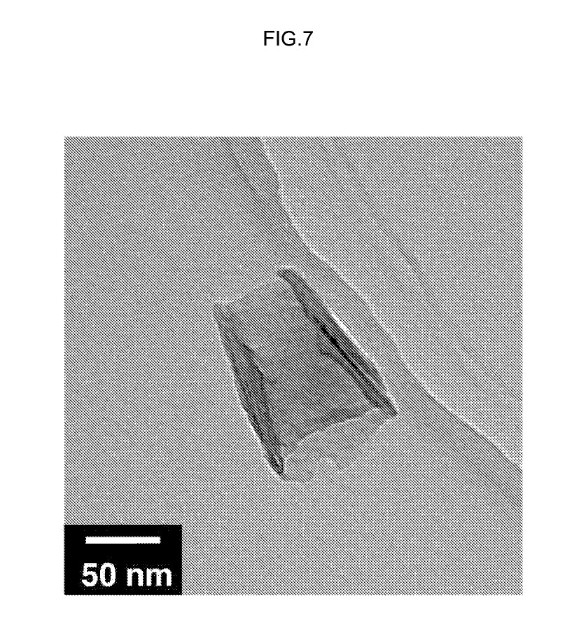

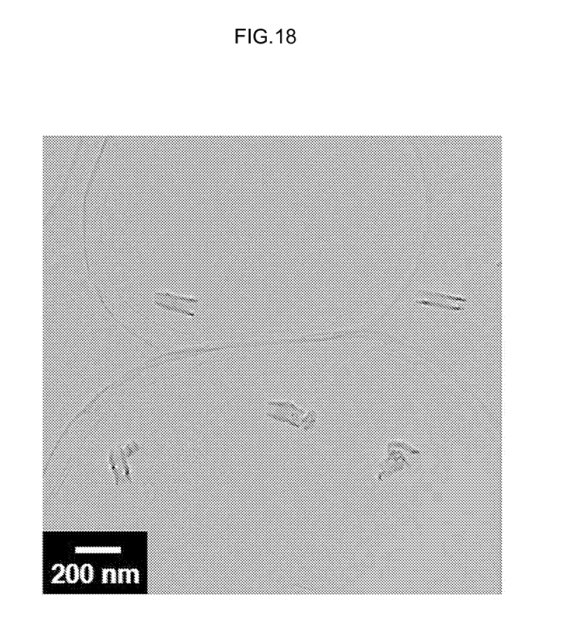

Transmission electron micrographs (TEM) are shown in FIG. 7 and FIG. 18. These transmission electron micrographs were taken by applying acceleration voltage of 200 kilovolt. FIG. 7 is a micrograph of the dodecylated derivative. FIG. 18 is a micrograph of the obtained dodecylated derivative taken by changing magnification.

In FIG. 7, the dodecylated derivative in a separated state was confirmed. With respect to the dodecylated derivative shown in FIG. 7, the length between a bottom surface and an upper surface is slightly larger than the bore diameter of the upper surface and the bottom surface. In FIG. 18, five dodecylated derivatives in a separated state were confirmed. Further, in FIG. 18, a dodecyl group in the derivative also can be confirmed.

(2) Confirmation of Dodecylation

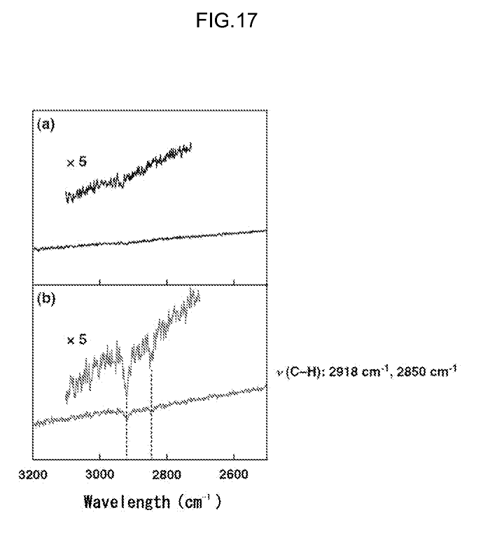

An IR (infrared) spectrum (measured by potassium bromide (KBr) tablet method) is shown in FIG. 17. FIG. 17 (a) is a result of the cup-stacked carbon nanotube. FIG. 17 (b) is a result of a reactant dodecylated after reducing the cup-stacked carbon nanotube with sodium naphthalenide. As shown in FIG. 17 (b), signals of v=2918 cm⁻¹ and 2850 cm⁻¹ were confirmed. This result means the presence of C—H bonding of a dodecyl group. From this result, it was confirmed that the reactant is the dodecylated cup-shaped nanocarbon, to which the n-dodecyl group was introduced.

(3) Confirmation of Separation to Cup-Shaped Nanocarbon

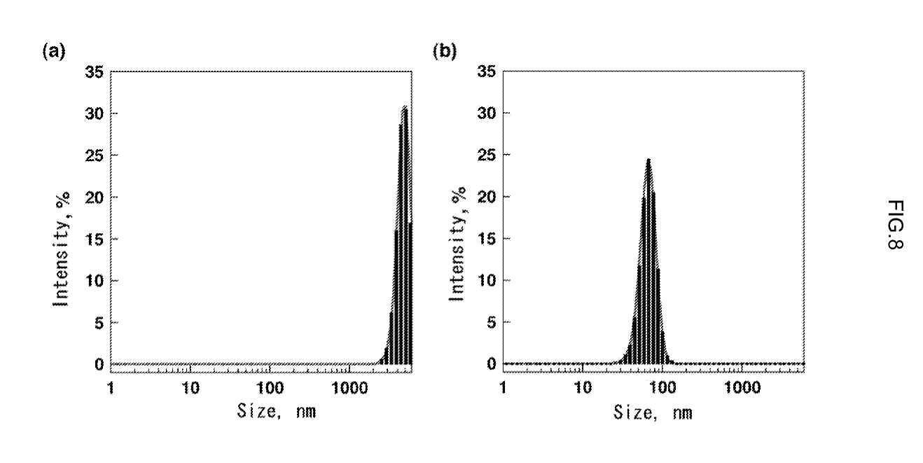

A size distribution chart of a dynamic light scattering measurement is shown in FIG. 8. FIG. 8 (a) shows a measurement result of the purified cup-stacked carbon nanotube. FIG. 8 (b) shows a measurement result of the dodecylated derivative. Each dynamic light scattering measurement was carried out at 25° C. in the THF. The size was an average size in the dynamic light scattering measurement result. The average size of the cup-stacked carbon nanotube and the dodecylated derivative is the average of the length in the longitudinal direction of each. As shown in FIG. 8 (a), the average size of the purified cup-stacked carbon nanotube was several thousand nm. In contrast, as shown in FIG. 8 (b), the average size of the dodecylated derivative was dozens of nm. From this result, it was confirmed that the cup-stacked carbon nanotube was separated into individual cup-shaped nanocarbon and that the dodecylated derivative was obtained. In this Example, “the average size” in the dynamic light scattering measurement indicates a number average particle diameter of stokes diameter of particle calculated from attenuation speed of autocorrelation function.

The dynamic light scattering was measured by particle size analyzer, LB-500 (trade name), manufactured by HORIBA Ltd. The same applies in the following. This analyzer can measure the particle size in the range of about 1 to 6000 nm.

(4) Dispersibility

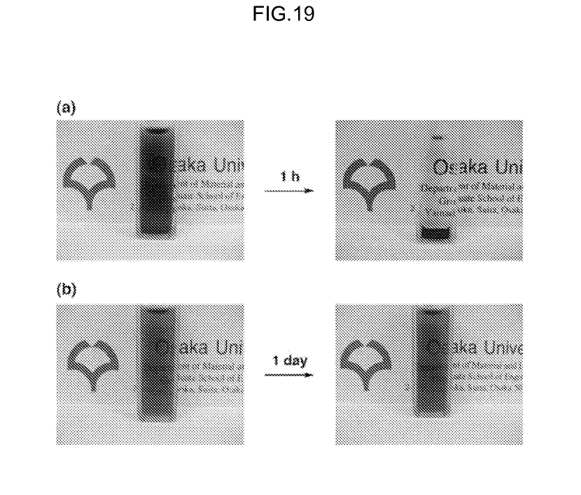

With respect to the purified cup-stacked carbon nanotube and the dodecylated derivative, suspensions were prepared and the dispersibility of each was confirmed. First, the purified cup-stacked carbon nanotube (0.001 g) was added to the THF (10 mL). This mixture was irradiated with ultrasonic waves at 70 watt for 15 minutes and obtained suspension. On the other hand, the dodecylated derivative (0.001 g) was added to the THF (10 mL). This mixture was irradiated with ultrasonic waves at 70 watt for 15 minutes and obtained suspension. These suspensions were left at rest and change thereof was observed. These results are shown in FIG. 19. FIG. 19 (a) shows photographs of the suspension of the purified cup-stacked carbon nanotube. FIG. 19 (b) shows photographs of the suspension of the dodecylated derivative. In FIGS. 19 (a) and (b), each left view is a photograph of the suspension right after the preparation and each right view is a photograph of the suspension after standing for one hour. As shown in FIG. 19 (a), the suspension of the cup-stacked carbon nanotube showed an uniform appearance right after the preparation. However, with respect to the suspension, separation of the cup-stacked carbon nanotube and the THF was confirmed after standing. In contrast, as shown in FIG. 19 (b), the dodecylated derivative maintained uniform dispersibility not only after the preparation of the suspension but also after standing. From these results, it was found that the cup-shaped nanocarbon was excellent in dispersibility as compared to the cup-stacked carbon nanotube.

(5) Various Characteristics

The dodecylated derivative obtained in this Example was suspended in various solvents and the dynamic light scattering measurement was carried out. Preparation of the suspension was carried out in the same manner as (4). As the solvent, THF, tetrachloroethylene, chloroform, acetonitrile, and benzonitrile were used. With respect to each suspension, viscosity, relative permittivity, and size were measured by the particle size analyzer. These results are shown in Table 1. The viscosity in Table 1 is at 25° C. The size is an average size in the dynamic light scattering measurement result. As shown in Table 1, in polar solvents such as acetonitrile and benzonitrile, an aggregation of the cup-shaped nanocarbon derivative was observed. However, as shown in Table 1, the cup-shaped nanocarbon derivative was not aggregated in other solvents such as THF. Accordingly, it was confirmed that the dispersibility of the cup-shaped nanocarbon derivative of this Example could be controlled by selecting the solvent. The reason for the aggregation in the polar solvent was not altogether clear. As for the reason, for example, it was considered that the cup-shaped nanocarbon derivative was aggregated because the affinity with the polar solvent was low due to low polarity of the cup-shaped nanocarbon derivative. More specifically, the reason may be an interaction among dodecyl groups of the cup-shaped nanocarbon derivative. However, this estimation does not limit the present invention.

TABLE 1

| | Viscosity | Relative permittivity | |
|---|---|---|---|
| Solvent | η (mPa · s) | εᵣ | Size (nm) |
| THF | 0.456 | 7.52 (22° C.) | 62.5 ± 14.1 |
| Tetrachloroethylene | 0.844 | 2.27 (30° C.) | 54.6 ± 9.5 |
| Chloroform | 0.537 | 4.81 (20° C.) | 46.0 ± 9.4 |
| Acetonitrile | 0.369 | 36.64 (20° C.) | 4350 ± 920 |
| Benzonitrile | 1.267 | 25.90 (20° C.) | 5500 ± 180 |

### Example 31

### Production of Cup-Shaped Nanocarbon Anion

Individual cup-shaped nanocarbon was separated from the cup-stacked carbon nanotube using a reducing agent different from that in Example 1. Then, salt containing cup-shaped nanocarbon anion was produced. In other words, individually separated cup-shaped nanocarbon anion was obtained by reducing the cup-stacked carbon nanotube with 1,1′-dibenzyl-3,3′-dicarbamoyl-1,1′,4,4′-tetrahydro-4,4′-bipyridine (it is also referred to as a BNA dimer or (BNA)₂).

The reducing agent, 1,1′-dibenzyl-3,3′-dicarbamoyl-1,1′,4,4′-tetrahydro-4,4′-bipyridine (BNA dimer) was synthesized as follows according to the description of Wallenfels, K.; Gellerich, M. Chem. Ber. 1959, 92, 1406. and Patz, M.; Kuwahara, Y.; Suenobu, T.; Fukuzumi, S. Chem. Lett. 1997, 567. A commercially available 1-benzyl-1,4-dihydronicotinamide hydrochloride salt (also referred to as BNA⁺Cl⁻) was used. First, 12 g of zinc powder was added to 20 mL of water and stirred. Then, copper sulfate aqueous solution (anhydrous copper sulfate 4 g+water 40 mL) was added thereto. Consequently, 20 mL of concentrated ammonia water and 100 mL of methanol were added. Thereafter, BNA⁺Cl⁻ solution (BNA⁺Cl⁻ 10 g+water 40 mL) was added while continuously stirring the mixture vigorously. The color of the mixture was changed promptly into yellow. Twenty minutes later, the mixture was filtered. With respect to the residue, under N₂ atmosphere, an extraction with 40 mL of thermal ethanol was repeated for four times. These ethanol solution were collected and ethanol was distilled away under reduced pressure at 313-323K (40 to 50° C.) until product began to precipitate. Thereafter, the solution was cooled to 253K (−20° C.). Generated light yellow crystal was leached under the N₂ atmosphere. An instrumental analysis value of this light yellow crystal was compared to the value described in J. Am. Chem. Soc. 1998, 120, 8060-8068, and confirmed that it was the target BNA dimer. The BNA dimer is sensitive to acid. Further, particularly in solution, the BNA dimer is sensitive to light and oxygen. Therefore, it requires caution in handling. UV spectrum of the BNA dimer is as follows.

### BNA Dimer:

UV(MeOH):268nm(ε=6.3×10³M⁻¹cm⁻¹), 348nm(ε=7.3×10³M⁻¹cm⁻¹)

The same cup-stacked carbon nanotube (1 mg) used in Example 1 as material was added to dehydrated and deaerated acetonitrile (10 mL). This mixture was irradiated with ultrasonic waves at 70 watt for 15 minutes to disperse the cup-stacked carbon nanotube. Then, 1×10⁻⁴ moL of 1,1′-dibenzyl-3,3′-dicarbamoyl-1,1′,4,4′-tetrahydro-4,4′-bipyridine (BNA dimer) was added to the obtained dispersion liquid. This solution was irradiated with a xenon lamp (at wavelength of 340 nm or more) for 12 minutes, the BNA dimer was photoexcited, and the cup-stacked carbon nanotube was reduced. This reduction reaction was tracked at 30 minutes intervals after the start of light irradiation by measurement with the ultraviolet-visible absorption spectroscopy. After the light irradiation was completed, the solution was dropped on a grid for the scanning electron micrograph (SEM) and the transmission electron microscope (TEM) measurement under the argon atmosphere. Then, it was vacuum-dried at room temperature. Accordingly, salt containing the cup-shaped nanocarbon anion was obtained.

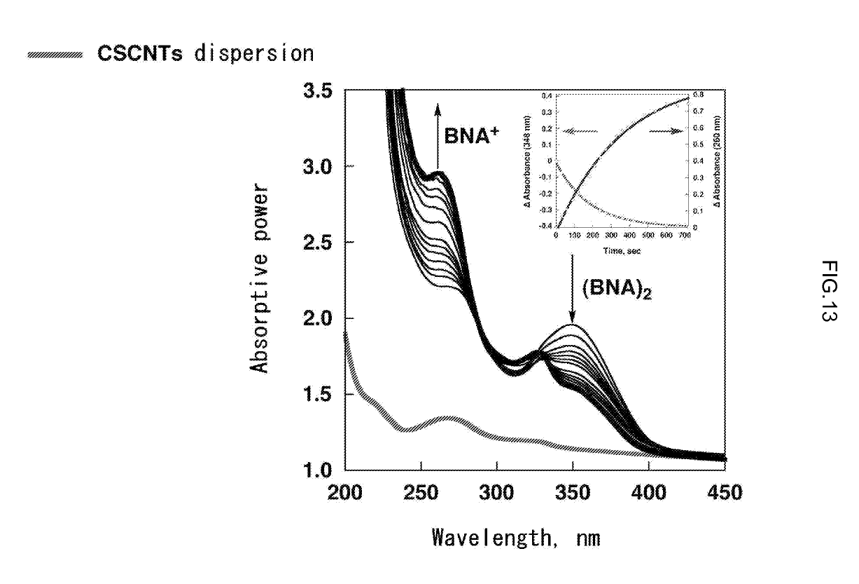

The results of reduction reaction in this Example tracked with the ultraviolet-visible absorption spectroscopy are shown in an UV spectrum of FIG. 13. In FIG. 13, the vertical axis indicates an absorptive power (absorbance) and the horizontal axis indicates a wavelength. In FIG. 13, the peak at about 350 nm is caused by (BNA)₂. As the reduction reaction progressed, this peak decreased. This indicates that the (BNA)₂ is degraded. On the other hand, the peak at about 260 nm is caused by cation (BNA⁺) that is generated due to degradation of the (BNA)₂. As the reduction reaction progressed, this peak increased. This indicates that the BNA⁺ is generated. These changes are also indicated in an insertion view of FIG. 13. In the insertion view of FIG. 13, the vertical axes indicate absorbance at the wavelength of 348 nm and 260 nm in FIG. 13. The horizontal axis indicates time after the start of light irradiation in the reduction reaction. As shown in the insertion view of FIG. 13, the peak at the wavelength of 348 nm was decreased as the reaction was progressed and 700 seconds after the start of the reaction, it became approximately 0. In contrast, although the peak at the wavelength of 260 nm was approximately 0 at the start of the reaction, the peak increased as the reaction progressed. Accordingly, it was confirmed that the (BNA)₂ was degraded and the BNA⁺ was generated. In other words, it was confirmed that the cup-stacked carbon nanotube was reduced and the cup-shaped nanocarbon anion was generated.

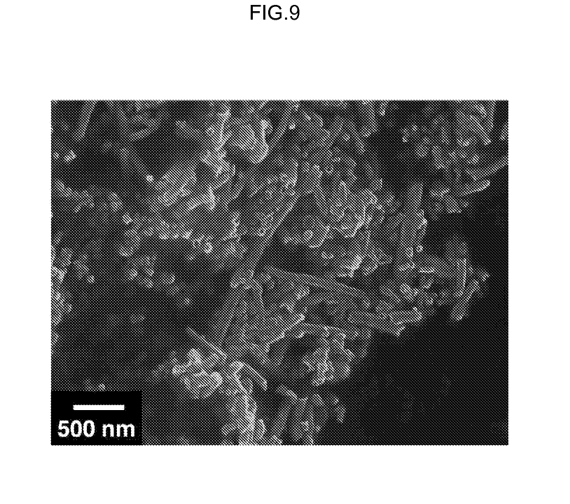

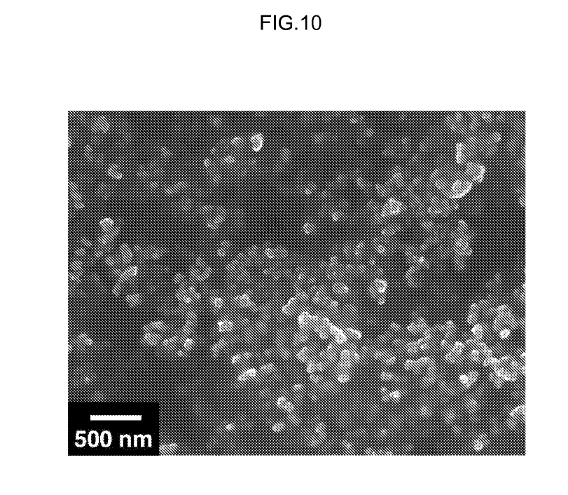

FIGS. 9 and 10 respectively show scanning electron micrographs (SEM). FIG. 9 is a micrograph of the cup-stacked carbon nanotube after purification and before reduction. In other words, FIG. 9 is a micrograph of the cup-stacked carbon nanotube used as the material in this Example. FIG. 10 is a micrograph of the cup-stacked carbon nanotube after reducing with the BNA dimer. In other words, FIG. 10 is a micrograph of individually separated cup-shaped nanocarbon obtained in this Example. As compared to FIG. 9 showing a micrograph of the cup-stacked carbon nanotube, it is found that the reactant in FIG. 10 is degraded into small molecules.

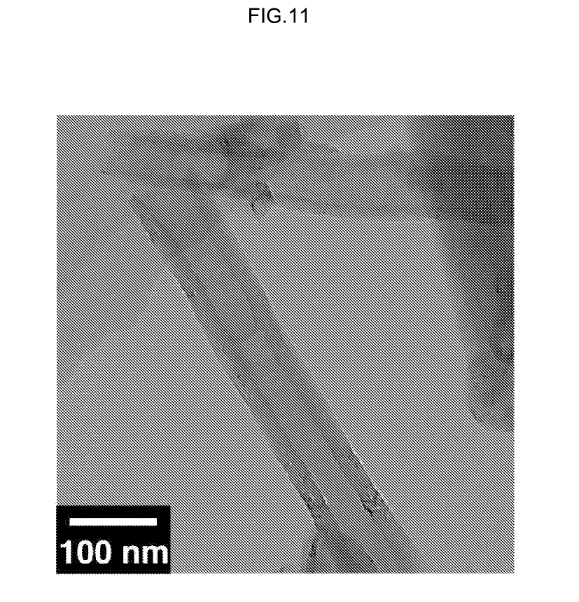

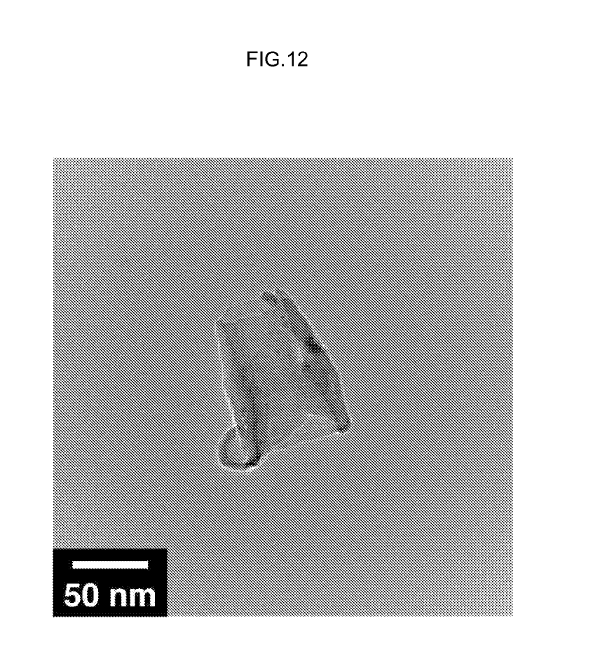

FIGS. 11 and 12 respectively show transmission electron micrographs (TEM). These transmission electron micrographs were taken by applying acceleration voltage of 200 kilovolt. FIG. 11 is a micrograph of the cup-stacked carbon nanotube after purification and before reduction. In other words, FIG. 11 is a micrograph of the cup-stacked carbon nanotube used as the material in this Example. FIG. 12 is a micrograph of the cup-stacked carbon nanotube after reducing with the BNA dimer. In other words, FIG. 10 is a micrograph of individually separated cup-shaped nanocarbon anion obtained in this Example. In FIG. 11, a cup-stacked structure was observed. In contrast, in FIG. 12, individually separated one cup-shaped nanocarbon anion was observed. Further, as shown in FIG. 12, with respect to the individual cup-shaped nanocarbon anion, the length between a bottom surface and an upper surface is slightly larger than the bore diameter.

### Example 4

### Production of Cup-Shaped Nanocarbon Anion

Salt containing cup-shaped nanocarbon anion was produced in the same manner as Example except that the amount of solvent and reactant used and reaction time were changed. The amount of the cup-stacked carbon nanotube used in this Example was 0.05 mg. The amount of the dehydrated and deaerated acetonitrile used was 3.1 mL. The amount of the BNA dimer used was 2.1×10⁻⁷ moL. The light irradiating time with the xenon lamp was 25 minutes. The reduction reaction was tracked by a measurement with the ultraviolet-visible absorption spectroscopy in the same manner as Example 3.

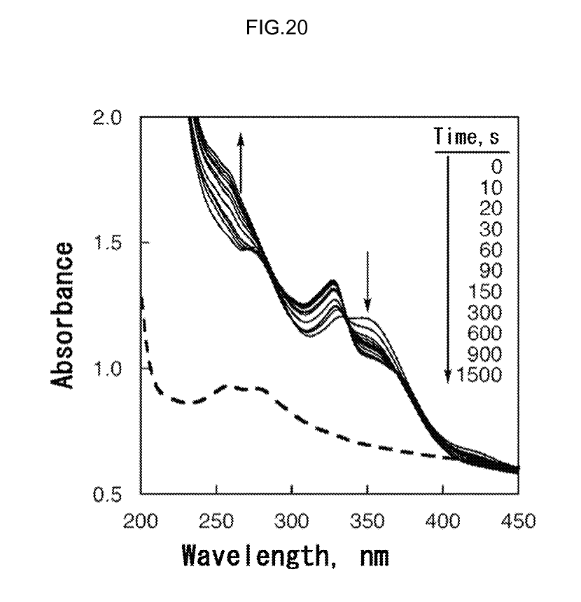

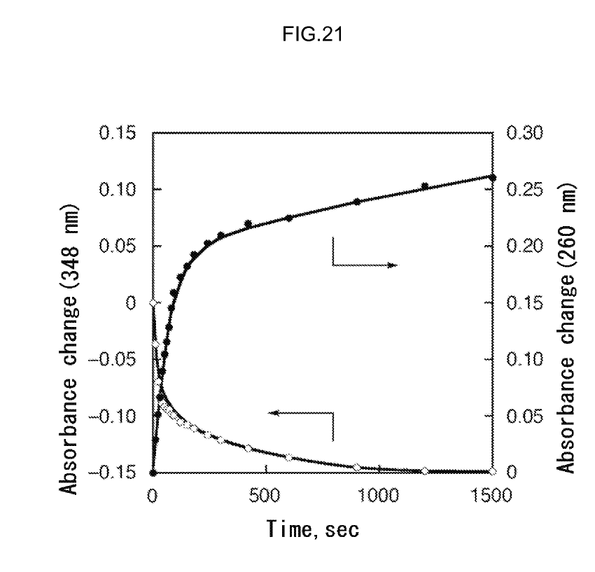

The results of the reduction reaction in this Example tracked with the ultraviolet-visible absorption spectroscopy are shown in the UV spectrum of FIG. 20. In FIG. 20, the vertical axis indicates an absorptive power (absorbance) and the horizontal axis indicates a wavelength. In FIG. 20, the peak at about 350 nm is caused by (BNA)₂. As the reduction reaction progressed, this peak decreased. This indicates that the (BNA)₂ is degraded. On the other hand, the peak at about 260 nm is caused by cation (BNA⁺) that is generated due to degradation of the (BNA)₂. As the reduction reaction progressed, this peak increased. This indicates that the BNA⁺ is generated. These changes are shown in FIG. 21. In FIG. 21, the vertical axes indicate absorbance at the wavelength of 348 nm and 260 nm in FIG. 20. The horizontal axis indicates time after the start of light irradiation in the reduction reaction. As shown in FIG. 21, the peak at the wavelength of 348 nm decreased as the reaction progressed and 1500 seconds after the start of the reaction, it became approximately 0. In contrast, although the peak at the wavelength of 260 nm was approximately 0 at the start of the reaction, the peak increased as the reaction progressed. Accordingly, it was confirmed that the (BNA)₂ was degraded and the BNA⁺ was generated. In other words, it was confirmed that the cup-stacked carbon nanotube was reduced and the cup-shaped nanocarbon anion was generated.

Elemental analysis value of the product in Example 4 measured was C, 90.86; H, 0.85; N, 0.36%. This value corresponds to calculation value of C, 93.06; H, 0.89; N, 0.37 from C₅₇₇(C₁₂H₁₃N₂O).26(H₂O). According to this measurement result, one BNA⁺ existed as counter ion relative to 577 carbon atoms of the cup-shaped nanocarbon anion.

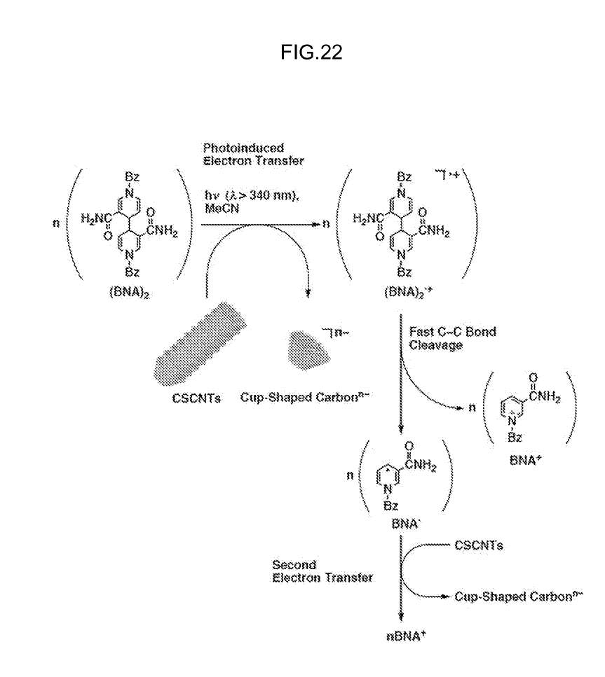

An expected reaction mechanism of Examples 3 and 4 is shown in a scheme of FIG. 22. As shown in FIG. 22, the (BNA)₂, i.e. the BNA dimer reduces the cup-stacked carbon nanotube (CSCNTs) by giving an electron. As a result, the cup-shaped nanocarbon anion is separated from the cup-stacked carbon nanotube. On the other hand, the BNA dimer becomes (BNA)₂⁺, i.e. the BNA dimer radical cation. The BNA dimer radical cation becomes BNA⁺ and BNA radical due to cleavage of C—C bonding. The BNA radical becomes BNA⁺ by giving electron to the other cup-stacked carbon nanotube. As a result, the cup-stacked carbon nanotube is reduced and the cup-shaped nanocarbon anion is separated. However, FIG. 22 and its explanation are an example of an expected mechanism, and do not limit the present invention.

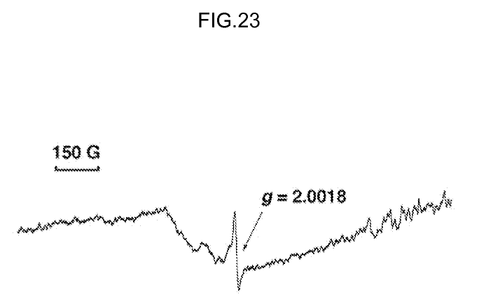

With respect to the cup-shaped nanocarbon anion salt (0.020 g) produced in this Example (Example 4), an ESR spectrum was measured in the solid state. The measurement temperature was 298K (25° C.). The result of the ESR spectrum is shown in FIG. 23. As shown in FIG. 23, the cup-shaped nanocarbon anion salt showed a sharp signal at a position of g=2.0018. From this signal, generation of the cup-shaped nanocarbon radical anion was confirmed in the same manner as Example 3.

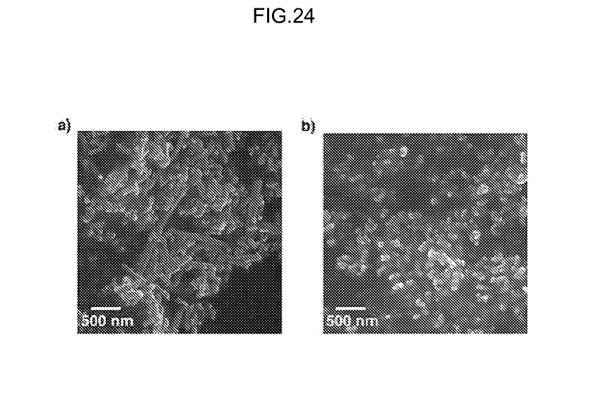

FIG. 24 is a scanning electron micrograph (SEM). FIG. 24 (a) is a micrograph of the cup-stacked carbon nanotube after purification and before reduction. In other words, FIG. 24 (a) is a micrograph of the cup-stacked carbon nanotube used as the material in this Example. FIG. 24 (b) is a micrograph of the cup-stacked carbon nanotube after reducing with the BNA dimer in this Example (Example 4). In other words, FIG. 24 (b) is a micrograph of individually separated cup-shaped nanocarbon. As compared to FIG. 24 (a) showing a micrograph of the cup-stacked carbon nanotube, it is found that the reactant in FIG. 24 (b) is degraded into small molecules.

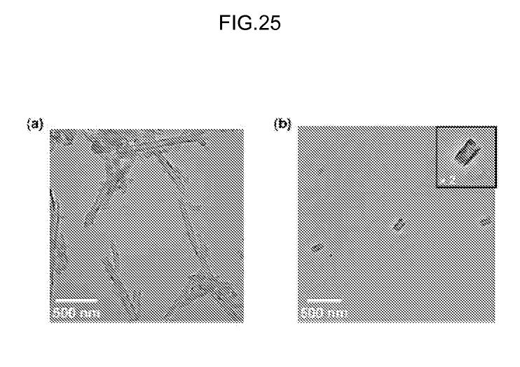

FIG. 25 shows transmission electron micrographs (TEM). These transmission electron micrographs were taken by applying acceleration voltage of 200 kilovolt. FIG. 25 (a) is a micrograph of the cup-stacked carbon nanotube after purification and before reduction. In other words, FIG. 25 (a) is a micrograph of the cup-stacked carbon nanotube used as the material in this Example. FIG. 25 (b) is a micrograph of the cup-stacked carbon nanotube after reducing by the BNA dimer. In other words, FIG. 25 (b) is a micrograph of individually separated cup-shaped nanocarbon anion obtained in this Example. In FIG. 25 (a), a cup-stacked structure was observed. In contrast, in FIG. 25 (b), three individually separated cup-shaped nanocarbon anions were observed. Further, as shown in FIG. 25 (b), with respect to each cup-shaped nanocarbon anion, the length between a bottom surface and an upper surface is slightly larger than the bore diameter. According to the observation in the micrograph of FIG. 25 (b), the bore diameter of the upper surface of the cup-shaped nanocarbon anion was about 50 nm and the length was about 200 nm.

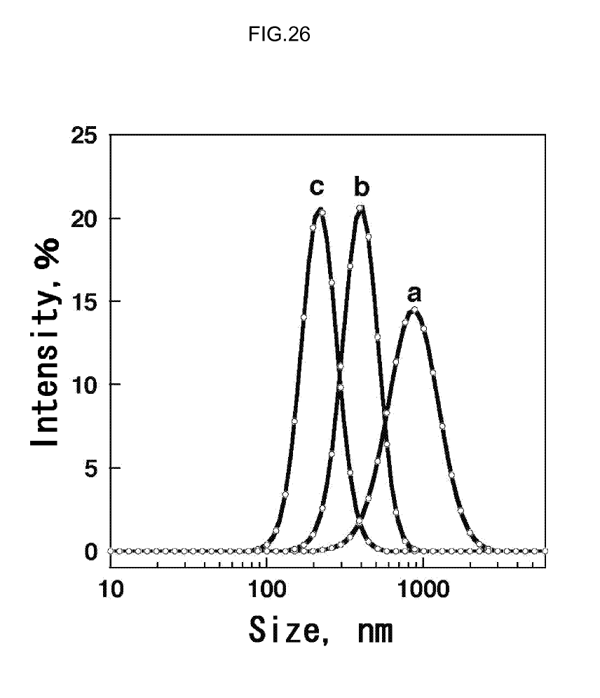

A size distribution chart of a dynamic light scattering measurement is shown in FIG. 26. In FIG. 26, the horizontal axis indicates a size and the vertical axis indicates a peak intensity. The definition of the size is same as that of the dynamic light scattering measurement performed in Example 2. The measurement temperature was 25° C. (298K). Dehydrated and deaerated acetonitrile was used as the solvent. In FIG. 26, the peak “a” indicates the measurement result of the purified cup-stacked carbon nanotube. The peak “c” indicates the measurement result of the cup-shaped nanocarbon anion obtained in this Example (Example 4). The peak “b” indicates the measurement result of the cup-stacked carbon nanotube after reducing in the same manner as this Example except that the amount of the BNA dimer used was reduced to one-tenth (2.1×10⁻⁸ moL). In FIG. 26, as indicated by the peak “a” the cup-stacked carbon nanotube showed the size of about 850±330 nm. In contrast, the peak “c” indicated the size of about 210±57 nm. This size shows good concordance with the length of the cup-shaped nanocarbon anion (about 200 nm) observed from the micrograph of FIG. 25 (b). Further, the peak “b” indicated the intermediate size between the peaks “a” and “c”. The cause thereof was not altogether clear. It was estimated that since the amount of the reducing agent used was small, some cup-shaped nanocarbons were not separated and left laminated. However this estimation does not limit the present invention at all. As described above, according to the present invention, only some of the cup-shaped nanocarbons may be separated.

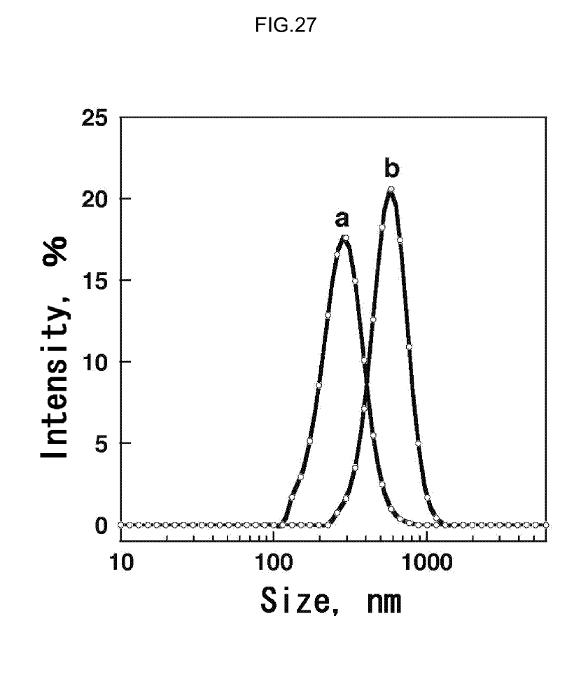

A size distribution chart of other dynamic light scattering measurement is shown in FIG. 27. In FIG. 27, the horizontal axis indicates a size and the vertical axis indicates a peak intensity. The definition of the size is same as described above. The measurement temperature was 25° C. (298K). In FIG. 27, the peak “a” indicates the measurement result of the cup-shaped nanocarbon anion obtained in this example (Example 4). Dehydrated and deaerated acetonitrile was used as the solvent. In FIG. 27, the peak “b” indicates the measurement result of the same cup-shaped nanocarbon anion measured in oxygen-saturated acetonitrile. With respect to the peak “a”, the size was about 270±90 nm. In contrast, with respect to the peak “b” the size was increased to about 540±90 nm. The reason thereof was not altogether clear. As for the reason, it was considered that the cup-shaped nanocarbon anion was oxidized by oxygen, became a neutral molecule, and relaminated. However the present invention is not limited to this consideration.

With respect to the cup-shaped nanocarbon anions in Examples 3 and 4, the size thereof was increased under the presence of oxygen even though the measurement condition such as solvent was changed. In contrast, even under the presence of the oxygen, the cup-shaped nanocarbon, to which the substituent is introduced, was not aggregated in solvents such as THF, tetrachloroethylene, chloroform, etc. Details are as described in Example 2. That is, it is considered that, due to introduction of the substituent, relamination was prevented and dispersibility was improved.

### INDUSTRIAL APPLICABILITY

As described above, according to the present invention, a method of producing the cup-shaped nanocarbon by separating individual cup-shaped nanocarbon from the cup-stacked carbon nanotube can be provided. Therefore, according to the present invention, individually separated cup-shaped nanocarbon can be provided. In this manner, by separating the individual cup-shaped nanocarbon, for example, solubility or dispersibility relative to the solvent is improved, and easier handling can be achieved. Further, the chemical modification such as producing a derivative by introducing the substituent easily can be achieved.

The cup-shaped nanocarbon derivative provided by the present invention develops various capabilities suitably according to for example, characteristics of the substituent. Therefore, the derivative of the cup-shaped nanocarbon of the present invention is expected to be applied to various usages. Examples of possible usage include, the same as the conventional carbon nanotube, functional materials such as molecular device capable of ultra high integration, storage materials for various gasses such as hydrogen, field emission display (FED) members, electronic materials, electrode materials, additives for resin molding, etc. Further, the derivative of the cup-shaped nanocarbon is expected to be applied to various usages such as an additive to an electrolyte used for a dye-sensitized solar cell, and an electrode of a fuel cell.

What is claimed is:

1. A method of producing a cup-shaped nanocarbon comprising the following processes (A) and (B).
(A) a process of preparing a cup-stacked carbon nanotube configured by laminating more than one cup-shaped nanocarbons in a height direction of a cup; and
(B) a process of separating the cup-shaped nanocarbon from the cup-stacked carbon nanotube by a reduction treatment of the cup-stacked carbon nanotube.

2. The method of producing according to claim 1, wherein
the cup-shaped nanocarbon is formed of graphene sheets, an upper portion of a cup and a bottom portion of a cup of the cup-shaped nanocarbon are opened, and an inner diameter and an external diameter of the cup-shaped nanocarbon are continuously increased from the bottom portion of the cup toward the upper portion of the cup, and wherein
with respect to two neighboring cup-shaped nanocarbons of the cup-stacked carbon nanotube, the bottom portion of the cup of one cup-shaped nanocarbon is inserted into an opening of the upper portion of the cup of the other cup-shaped nanocarbon, and thereby the both cup-shaped nanocarbons are laminated in the height direction of the cup.

3. The method of producing according to claim 1, wherein
in the process (B), the reduction treatment is carried out by using a reducing agent.

4. The method of producing according to claim 3, wherein
a redox potential of the reducing agent is −0.5V or less with an electric potential of saturated calomel electrode being considered as a standard (0V).

5. The method of producing according to claim 3, wherein
the reducing agent is an organic reducing agent.

6. The method of producing according to claim 5, wherein
the organic reducing agent is an aromatic anion.

7. The method of producing according to claim 5, wherein
the organic reducing agent is at least one of alkali metal naphthalenide having substituent and alkali metal naphthalenide having no substituent.

8. The method of producing according to claim 5, wherein
the organic reducing agent is sodium naphthalenide.

9. The method of producing according to claim 5, wherein
the organic reducing agent is at least one of a photoexcitation active specie of dihydropyridine dimer having substituent and a photoexcitation active specie of dihydropyridine dimer having no substituent.

10. The method of producing according to claim 9, wherein
the organic reducing agent is a photoexcitation active specie of 1,1′-dibenzyl-3,3′-dicarbamoyl-1,1′,4,4′-tetrahydro-4,4′-bipyridine (BNA₂).

11. The method of producing according to claim 3, wherein
in the process (B), a treatment is carried out using the reducing agent in an organic solvent.

12. The method of producing according to claim 3, wherein
in the process (B), a treatment is carried out using the reducing agent in an inert gas atmosphere.

13. The method of producing according to claim 1, further comprising
the process (C).
(C) a process of reacting the cup-shaped nanocarbon obtained in the process
(B) with an electrophilic agent to introduce a substituent into the cup-shaped nanocarbon.

14. The method of producing according to claim 13, wherein
the electrophilic agent is represented by the following chemical formula (1).
R—CH₂—X (1)
wherein the chemical formula (1),
R represents hydrogen atom, straight chain or branched alkyl group;
the straight chain or branched alkyl group may include or may not include a substituent;
the alkyl group may be interrupted or may not be interrupted by at least one of an oxy group (—O—) and an amido group (—CONH—); and
X represents an elimination group.

15. The method of producing according to claim 14, wherein
R in the chemical formula (1) is the straight chain or branched alkyl group;
and the carbon number of R is 1 to 30.

16. The method of producing according to claim 14, wherein
R in the chemical formula (1) is the straight chain or branched alkyl group;
and the carbon number of R is 5 to 20.

17. The method of producing according to claim 14, wherein
X in the chemical formula (1) is halogen, a methylsulfonyl group (CH₃SO₂—), a trifluoromethylsulfonyl group (CF₃SO₂—), or a chloromethylsulfonyl group (ClCH₂SO₂—).

18. The method of producing according to claim 14, wherein
X in the chemical formula (1) is bromine or iodine.

19. The method of producing according to claim 13, wherein
the process (C) is carried out in an organic solvent.

20. The method of producing according to claim 13, wherein
the process (C) is carried out in an inert gas atmosphere.

21. A cup-shaped nanocarbon, wherein the cup-shaped nanocarbon is produced by a method of producing according to claim 1.

22. A cup-shaped nanocarbon, wherein the nanocarbon molecule is a negatively-charged anionic molecule.

23. A cup-shaped nanocarbon, wherein the cup-shaped nanocarbon is produced by a method of producing according to claim 13.

24. A cup-shaped nanocarbon, wherein the cup-shaped nanocarbon is a derivative having a substituent.

25. The cup-shaped nanocarbon according to claim 24, wherein
the substituent is represented by the following chemical formula (2)
R—CH₂— (2)
wherein the chemical formula (2),
R represents hydrogen atom, straight chain or branched alkyl group;
the straight chain or branched alkyl group may include or may not include a substituent; and
the alkyl group may be interrupted or may not be interrupted by at least one of an oxy group (—O—) and an amido group (—CONH—).

26. The cup-shaped nanocarbon according to claim 25, wherein
R in the chemical formula (1) is the straight chain or branched alkyl group; and
the carbon number of R is 1 to 30.

27. The cup-shaped nanocarbon according to claim 25, wherein
R in the chemical formula (1) is the straight chain or branched alkyl group; and
the carbon number of R is 5 to 20.
